(19) United States
(12) Patent Application Publication
(10) Pub. No.: US 2011/0003599 A1
(43) Pub. Date: Jan. 6, 2011

(54) WIRELESS COMMUNICATION APPARATUS AND WIRELESS COMMUNICATION SYSTEM

(75) Inventors: Hajime KANZAKI, Hiratsuka (JP); Satoshi Tamaki, Kokubunji (JP); Ichiro Murata, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/830,813

(22) Filed: Jul. 6, 2010

(30) Foreign Application Priority Data
Jul. 6, 2009 (JP) 2009-159411

(51) Int. Cl. H04W 72/08

(52) U.S. Cl. 455/452.2; 455/450

(57) ABSTRACT

A wireless communication system includes plural wireless base station apparatuses and plural mobile station apparatuses, in which the base station apparatuses and mobile station apparatuses are capable of communication with each other via radio resources, each base station apparatus allocates guaranteed resources to be allocated to a mobile station apparatus for a given duration for transmission/reception of data with a specified capacity among data to be transmitted/received and includes a resource allocation notification unit that notifies the mobile station apparatus of the results of allocation performed by the resource allocation unit. A wireless communication base station and a wireless mobile station in the wireless communication system are also provided.

### CLAIM OF PRIORITY

The present application claims priority from Japanese patent application JP 2009-159411 filed on Jul. 6, 2009, the content of which is hereby incorporated by reference into this application.

### FIELD OF THE INVENTION

The present invention relates to a wireless communication system in which data transmission and reception take place between a wireless base station apparatus and a wireless mobile station. The invention also relates to a wireless communication base station and a wireless mobile station in such a wireless communication system. Particularly, the invention relates to a technique in which a wireless base station apparatus manages allocation of wireless resources to wireless mobile stations.

### BACKGROUND OF THE INVENTION

Generally, in a digital mobile communication system utilizing OFDMA (Orthogonal Frequency Division Multiple Access), communication with mobile stations is performed using resources partitioned into units of frequency and time. As discussed in Wang Anchun, Xiao Liang, Zhou Shidong Xu Xiiin, Yao Yan, “Dynamic resource management in the fourth generation wireless systems,” Proc. ICCT 2003, a base station performs scheduling in which it measures a reception quality from the interference and received power for each resource, decides which resource to be used for communication with each mobile station from the measured reception quality, decides a transmission rate, notifies a mobile station about the resource, and initiates communication with the mobile station. In a fourth generation wireless communication system like IMT-Advanced, it becomes possible that respective base stations perform communication using a same frequency and different base stations utilize a common resource in order to improve frequency usage efficiency, as suggested in 3GPP, TR36.814 v0.4.1, February 2009 and IEEE802.16m, System Description Document, IEEE802.16m-08/003r8, April 2009. Here, the reception quality of each resource depends on interferences from other cells.

Besides conventional best effort services, lately, there are increasing demands for services for which it is important to guarantee QoS (Quality of Service) in terms of a transmission rate and delay time, for example, VoIP (Voice over Internet Protocol) and motion picture transmission. For example, in motion picture transmission, because the transmission rate changes depending on picture quality, it is required to guarantee a minimum sustained rate to maintain picture quality and further to achieve a high transmission rate in accordance with a motion picture rate. Therefore, in QoS guaranteed resource allocation as disclosed in JP-A-2008-211759 and JP-A-2006-157323, resources are preferentially allocated for a service with a high QoS guarantee priority to achieve guaranteeing a minimum sustained rate and, then, resource allocation is performed for a service with a low priority

### SUMMARY OF THE INVENTION

In this context, in resource allocation according to conventional scheduling, one base station cannot know resource allocation performed by other base stations. Consequently, when another base station changes resource allocation, its interference changes, which in turn varies a given transmission rate, thus making it difficult to guarantee a minimum sustained rate. Interference change due to downlink resource allocation changes in adjacent base stations is depicted in FIGS. 2 and 3. In downlink resource allocation, a mobile station measures interference from another cell and reports it to its base station. It is assumed that resources are numbered and channels available in this system are five resources numbered 1 to 5 in total. As can be seen in FIG. 2, a base station 201 communicates with a mobile station (abbreviated as MS especially in the attached drawings) 203 and a base station 202 communicates with a mobile station 204. At the present moment, the base station 201 has allocated a resource index 1 to the mobile station 203 and the base station 202 has allocated a resource index 4 to the mobile station 204 for communication. At this time, when each mobile station measures interference, interferences on resources with resource indices 2, 3, and 5 are small, because these resources are not being used. Then, each base station changes allocation to a resource that experiences a small interference and can achieve a high transmission rate, based on the interference measurement results from the mobile stations, as can be seen in FIG. 3. If it is here assumed that the base station 201 and the base station 202 have allocated a resource index 5 to the mobile stations, inter-cell interference becomes larger than the interference measurement results from the mobile stations. Each base station decides a transmission rate from the interference measurement results and transmits data. Thus, in the event that the interference occurring when the resource is allocated is larger than measured interference, a transmission rate at which data is actually receivable by a mobile station will be lower than the transmission rate determined by each base station. In the event that the transmission rate of data receivable by a mobile station is lower than the transmission rate of data transmitted by the base station, packet loss occurs and the transmission rate varies. As noted above, in a case where another base station changes resource allocation during a period after interference is measured until resource allocation is performed, interference on each resource changes and the transmission rate changes. In that case, it is therefore difficult to guarantee a minimum sustained rate by resource allocation according to conventional scheduling. On the assumption that resources experience given interference, if resources are fixedly allocated to guarantee a minimum sustained rate, some resources to which no data is assigned exist, which deteriorates power efficiency. Because interference in total becomes larger, the number of mobile stations to be served by a base station decreases. Fixed resource allocation makes it difficult to achieve a high transmission rate. Meanwhile, for uplink where a base station measures interference and performs resource allocation, the same problem arises.

One aspect of the present invention to solve at least one of the problems noted above resides in a wireless communication system comprising a plurality of wireless base station apparatuses and a plurality of mobile station apparatuses, wherein the wireless base station apparatuses and the mobile station apparatuses are capable of communication with each other via radio resources. Each wireless base station apparatus is configured to allocate first resources for transmission/reception of data with a specified capacity among data to be transmitted/received for a given period and notify results of allocation to the mobile station apparatuses. Further, in another aspect, when a wireless base station apparatus allocates resources to mobile station apparatuses, the base station is configured to allocate second resources to the mobile station apparatuses for a duration shorter than the given duration for transmission/reception of data other than the data with a specified capacity among the data to be transmitted/received.

According to one aspect of the present invention, each wireless base station apparatus allocates first resources for a given period, thereby resulting in reducing fluctuation in interferences. It is thus possible to stabilize a transmission rate and guarantee a minimum sustained rate.

### BRIEF DESCRIPTION OF THE DRAWINGS

FIG. 1 is a block structural diagram of a scheduling unit 703 in a first embodiment;

FIG. 2 is a first conceptual diagram depicting interference change due to resource allocation change;

FIG. 3 is a second conceptual diagram depicting interference change due to resource allocation change;

FIG. 4 shows an example of a mobile wireless communication system to which the invention is applied;

FIG. 5A shows one example of arrangement of base stations in the mobile communication system to which the invention is applied;

FIG. 5B shows another example of arrangement of base stations in the mobile communication system;

FIG. 6 shows an example of a communication frame which is transmitted and received between a mobile station and a base station;

FIG. 7 is a block structural diagram of a base station including software-implemented components;

FIG. 8 is a block structural diagram of a mobile station including software-implemented components;

FIG. 9 is a sequence diagram in which a base station performs resource allocation to a mobile station by scheduling by way of example;

FIG. 10 shows a table of reception quality measurement results reported by each mobile station 902 by way of example;

FIG. 11 shows a structure of an interference table 106;

FIG. 12 shows a structure of an interference fluctuation table 107;

FIG. 13 shows a structure of a allocating duration table 102;

FIG. 14 is a flowchart of operations of a interference measurement unit 104;

FIG. 15 is a flowchart of operations of a interference fluctuation measurement unit 105;

FIG. 16 is a first flowchart of operations of a guaranteed resource classification unit 101;

FIG. 17 is a second flowchart of operations of the guaranteed resource classification unit 101;

FIG. 18 is a block structural diagram of an allocated resource decision unit 103;

FIG. 19 is a flowchart of a guaranteed allocation unit 1801;

FIG. 20 is a flowchart of an additional allocation unit 1802;

FIG. 21 shows a structure of a cost function table 2100;

FIG. 22A shows a first example representing how guaranteed resources have influence on other base stations;

FIG. 22B shows a second example representing how guaranteed resources have influence on other base stations;

FIG. 23 is a block structural diagram of the scheduling unit 703 in a second embodiment;

FIG. 24 is a flowchart of operations of a guarantee calculation unit 2301;

FIG. 25 shows a structure of a guarantee table 2308;

FIG. 26 is a flowchart of operations of the guaranteed allocation unit 1801 in the second embodiment;

FIG. 27 is a block structural diagram of the scheduling unit 703 in a third embodiment;

FIG. 28 is a flowchart of operations of an initial state updating unit 2709;

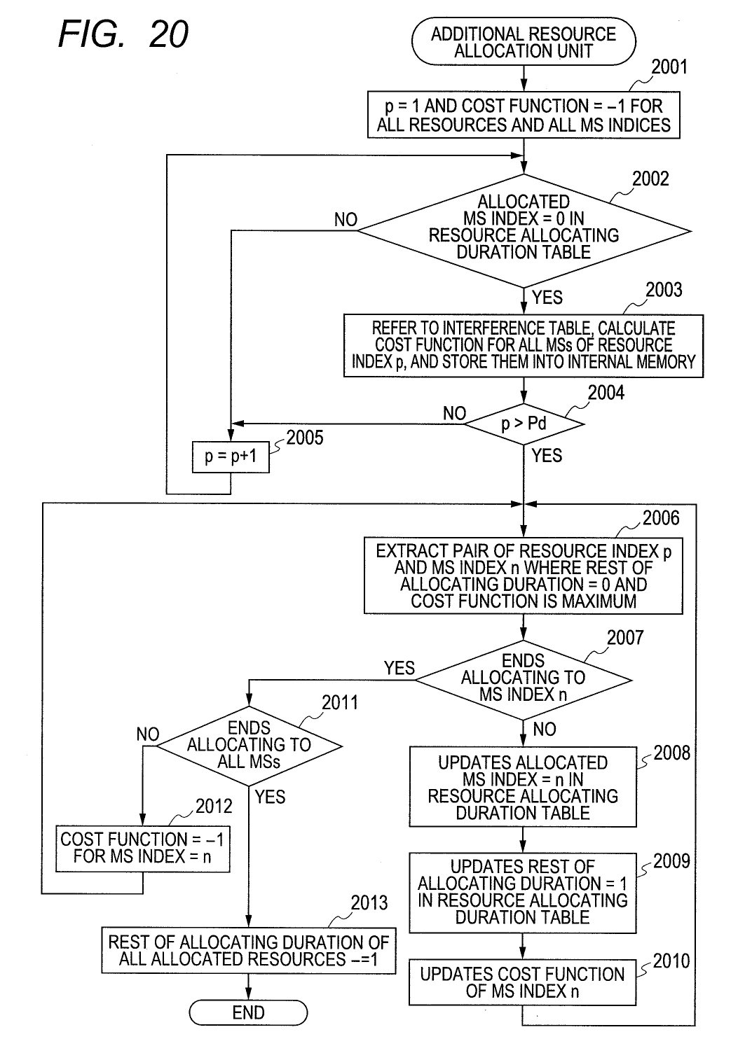

FIG. 20 is a block structural diagram of the scheduling unit 703 in a fourth embodiment;

FIG. 30 is a flowchart of operations of a dummy data insertion 2910;

FIG. 31 shows an interference fluctuation table in a fifth embodiment;

FIG. 32 shows a guaranteed resource judgment table;

FIG. 33 shows a guarantee table in a seventh embodiment;

FIG. 34 shows a sequence of resource allocation in the fifth embodiment;

FIG. 35 shows a sequence of resource allocation in a sixth embodiment;

FIG. 36 shows a sequence of resource allocation in the seventh embodiment;

FIG. 37 is a hardware structural diagram of a base station;

FIG. 38 shows the structure of the allocating duration table 102 where resources are allocated to mobile stations;

FIG. 39 is a hardware structural diagram of a mobile station;

FIG. 40 is a block structural diagram of a mobile station including software-implemented components in the fifth embodiment;

FIG. 41 is a block structural diagram of a mobile station including software-implemented components in the sixth embodiment;

FIG. 42 is a block structural diagram of a mobile station including software-implemented components in the seventh embodiment;

FIG. 43 shows a structure of a QoS table;

FIGS. 44A and 44B represent comparison about transmission rates between the invention and related art;

FIG. 45 is a flowchart for deciding whether or not allocation yielding up to a minimum sustained rate is complete;

FIG. 46 shows a structure of a MCS index table;

FIG. 47 shows a structure of an MCS table;

FIG. 48 is a conceptual diagram of a case where an MCS (Modulation and Coding Scheme) is selected based on an interference value 4800; and

FIG. 49 is a flowchart for modifying the threshold value ε of interference fluctuation.

### DETAILED DESCRIPTION OF THE PREFERRED EMBODIMENTS

In the following, with reference to the drawings, detailed descriptions are provided for a wireless communication system to which the invention is applied and a wireless communication base station and a wireless mobile station in the wireless communication system.

### First Embodiment

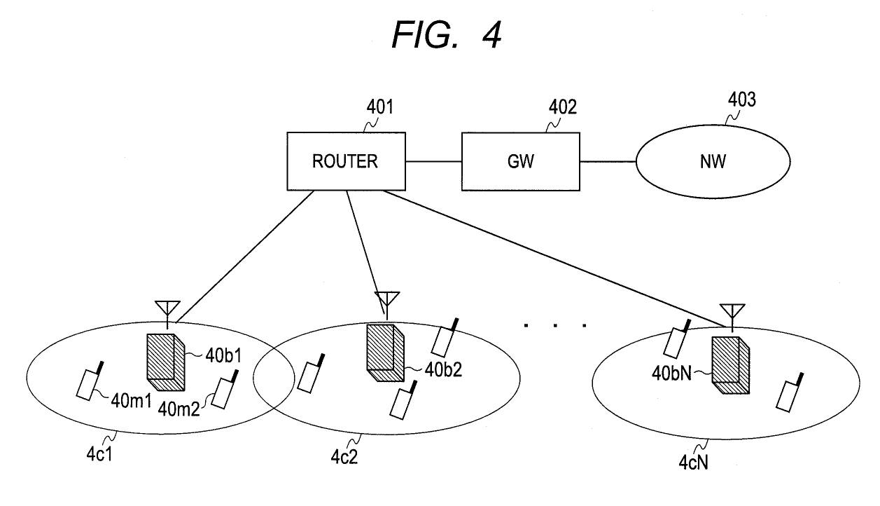

A wireless communication system pertaining to the present embodiment is applied in network architecture, for example, as is shown in FIG. 4. The wireless communication system comprises a plurality of base stations (40b1, 40b2, . . . 40bN) and a plurality of mobile stations (40m1, 40m2, . . . ) communicating by radio with the base stations within cells (4c1, 4c2, . . . 4cN) representing the radio coverages of the base stations. The base stations are connected to an external communication network, e.g., the Internet (NW) 403 via a router (or L3 switch) 401 and a gateway (GW) 402. However, the network architecture relevant to the present embodiment is not limited to this architecture as shown in FIG. 4 and may be any network architecture enabling radio access between base stations and mobile stations.

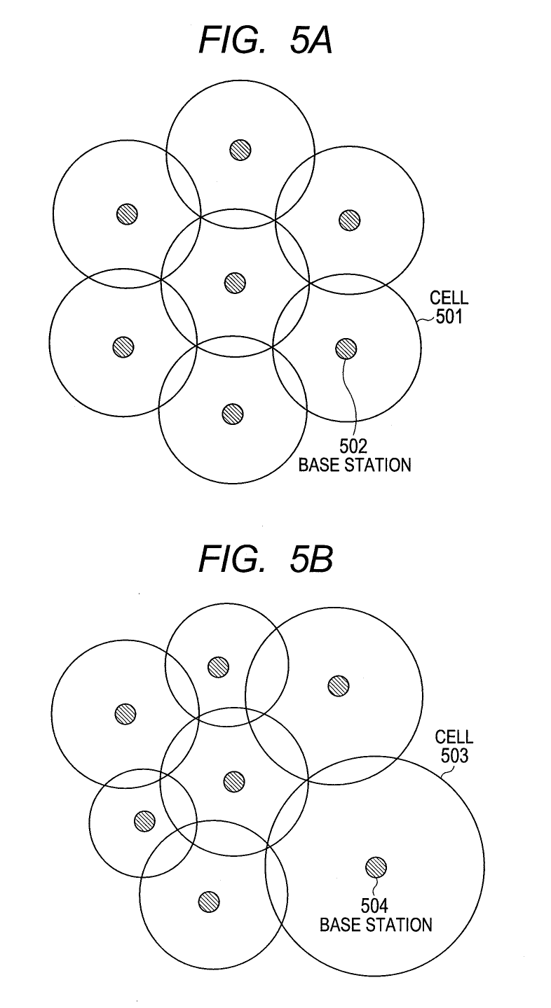

Planar arrangements of base stations are shown in FIGS. 5A and 5B. If cells are uniform in radius, they are typically arranged in a hexagonal shape. An arrangement of base stations in that case is shown in FIG. 5A. The cell of a base station 502 is denoted by reference numeral 501. If cells are nonuniform in radius, they are not hexagonally arranged; instead, there is an irregular arrangement of base stations as shown in FIG. 5B. The present embodiment involves base stations arranged in each of these arrangements.

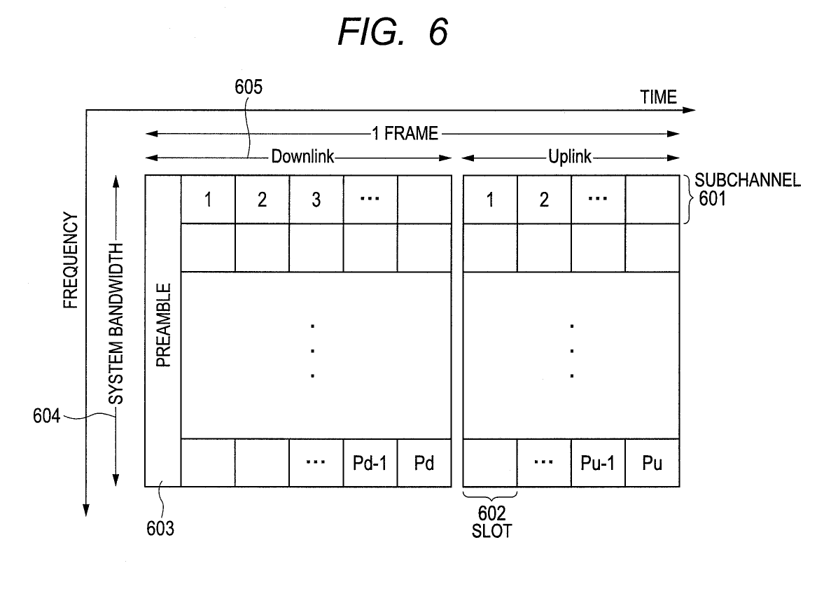

An example of resources which are used for wireless communication in the present embodiment is shown in FIG. 6. A frequency bandwidth available for communication is referred to as a system bandwidth 604. The system bandwidth is divided in units of subchannels 601 and a time frame is divided in units of slots 602. A resource consists of one subchannel and one slot in frequency and time domains. A preamble 603 to be used for synchronization or the like is inserted in the beginning of downlink 605 resources. Here, a resource consisting of one subchannel and one slot is a minimum unit that can be allocated to a mobile station. Resources in such a structure are assumed to be used in communication based on, for example, OFDMA (Orthogonal Frequency Division Multiple Access) of TDD (Time Division Duplex), when assumed.

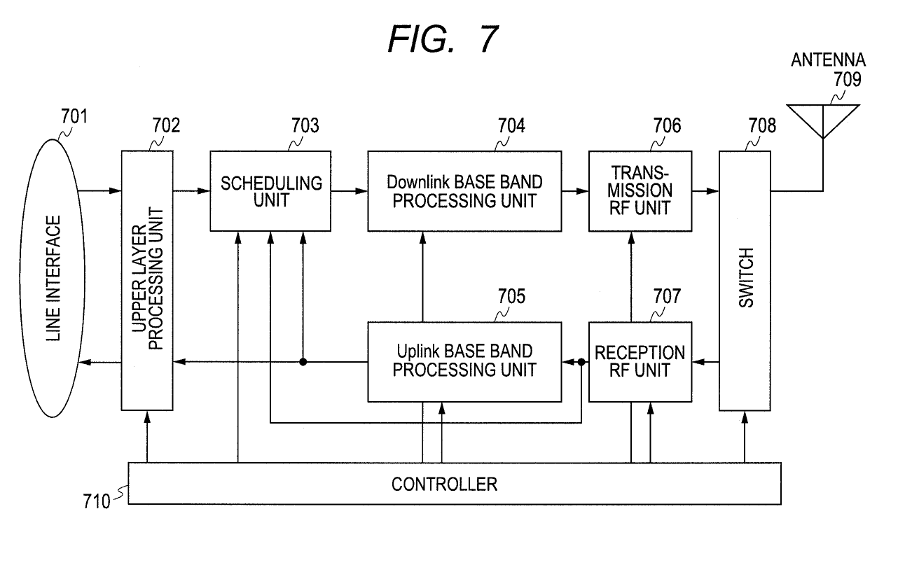

The number of downlink resources is denoted by Pd and the number of uplink resources is denoted by Pu, and each resource is numbered 1, 2, . . . , Pd, and 1, 2, . . . , and Pu. Abase station decides a resource to be used for communication with a mobile station from among the resources shown in FIG. 6 and allocates the resource to the mobile station, thereby carrying out downlink and uplink communication. However, not limited to a frame structure shown in FIG. 6, there are different resource definitions in terms of time, frequency, code, etc. implementing communication by radio. For example, in the case of TDMA (Time Division Multiple Access), the system bandwidth is not divided into subchannels. In the case of FDMA (Frequency Division Multiple Access), a time frame is not divided into slots. The present embodiment is not limited to using the frame structure shown in FIG. 6 and can also be applied in a system that uses different frequencies for uplink and downlink as in, e.g., FDD (Frequency Division Duplex). Then, a structure including software-implemented components of a base station of the present embodiment is described, using a block structural diagram as shown in FIG. 7.

The base station includes a controller 710, an antenna 709 which transmits and receives radio waves to/from a mobile station, a switch 708 connected to the antenna 709 to switch between transmission and reception, a NW interface 701 which is connected to a connection link with a router 401, an upper layer controlling unit 702 connected to the NW interface 701, a transmission RF (Radio Frequency) unit 706 and a reception RF unit 707 connected to the switch 708, a base band processing unit 704 for base station connected to the transmission RF unit 706, an base band processing unit 705 for mobile station connected between the upper layer controlling unit 702 and the reception RF unit 707, and a scheduling unit 703 connected between the upper layer controlling unit 702 and the base band processing unit 704 for base station.

A hardware structure of a base station is described, using a block structural diagram as shown in FIG. 37. The base station includes a transmitter and receiver 3703 to transmit and receive radio signals, a memory 3702 to store program modules, a processor 3701 to execute program modules, IFs 3704 which are connected to a network 3705, and a data memory 3706 to store data. The transmission RF unit 706, reception RF unit 707, switch 708, and antenna 709 are contained in the transmitter and receiver 3703 to transmit and receive radio signals. The NW interface 701 is contained in each IF 3704 and connected to the network 3705. Other function blocks are program modules which are executed by the processor 3701 and these program modules are stored in the memory 3702. The scheduling unit 703 performs scheduling and allocates resources to mobile stations, referring to various tables created in the data memory 3706, as will be described later.

As for downlink, data transferred from the NW interface 701 is first processed by the upper layer controlling unit 702. Then, the scheduling unit 703 measures interference on each resource and decides downlink and uplink resource allocations, using service information from the upper layer controlling unit 702, a signal from the reception RF unit 707, and a signal from the base band processing unit 705 for mobile station. However, information that is used by the scheduling unit 703 is not limited to those mentioned above. It is conceivable to use information from other processing units. Following that, data is transferred to the base band processing unit 704 for base station and undergoes RF processing in the transmission RF unit 706. Then, the switch 708 switches to transmission and a radio signal is transmitted from the antenna 709. The above process operates according to control signals from the controller 710. The controller 710 is a program module which is executed by the processor 3701.

As for uplink, the switch 708 first switches to reception and a radio signal is received by the antenna 709. Then, the received data undergoes RF processing in the reception RF unit 707. Following that, the data is transferred to the base band processing unit 705 for mobile station, processed by the upper layer controlling unit 702, and transmitted from the NW interface 701. The above process operates according to control signals from the controller 710.

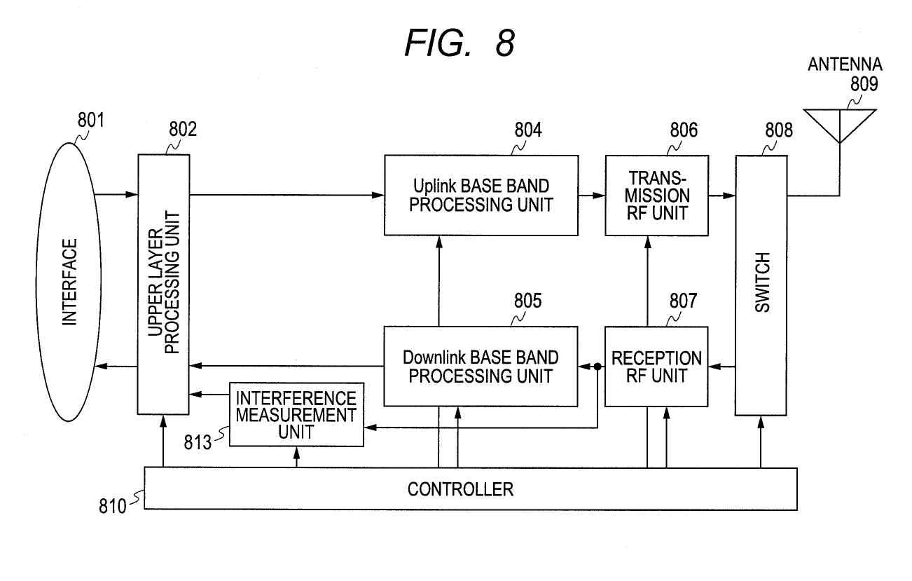

FIG. 8 is a block structural diagram of a mobile station including software-implemented components, representing one embodiment of a mobile station relevant to the present embodiment. The mobile station includes a controller 810, an antenna 809 to transmit and receive radio waves to/from a base station, a switch 808 connected to the antenna 809 to switch between transmission and reception, an upper layer controlling unit 802 connected to an interface 801, a transmission RF unit 806 and a reception RF unit 807 connected to the switch 808, an uplink base band processing unit 804 connected between the upper layer controlling unit 802 and the transmission RF unit 806, and a downlink base band processing unit 805 connected between the upper layer controlling unit 802 and the reception RF unit 807.

A hardware structure of a mobile station is described, using a block structural diagram as shown in FIG. 39. The mobile station includes a transmitter and receiver 3903 to transmit and receive radio signals, a memory 3902 to store program modules, a processor 3901 to execute program modules, IFs 3904 which are connected to a user interface 3905, and a data memory 3906 to store data. The transmission RF unit 806, reception RF unit 807, switch 808, and antenna 809 are contained in the transmitter and receiver 3903 to transmit and receive radio signals. The interface 801 is contained in each IF 3904 and connected to the user interface 3905. Other function blocks are program modules which are executed by the processor 3901. These program modules are stored in the memory 3902 and operate according to data from the user interface 3905.

As for uplink, data transferred from the user interface 3905 is first processed by the upper layer controlling unit 802. Then, the data is transferred to the uplink base band processing unit 804 and undergoes RF processing in the transmission RF unit 806. The switch 808 switches to transmission and a radio signal is transmitted from the antenna 809. The above process operates according to control signals from the controller 810.

As for downlink, the switch 808 first switches to reception and a radio signal is received by the antenna 809. Then, the received signal undergoes RF processing in the reception RF unit 807. Following that, the data is transferred to the downlink base band processing unit 705, processed by the upper layer controlling unit 702, and output to the user interface 801. An interference measurement unit 813 measures interference on a resource and transfers the measured interference to the upper layer controlling unit 802. The above process operates according to control signals from the controller 810. Here, the user interface is not limited to this and an interface with another device is conceivable.

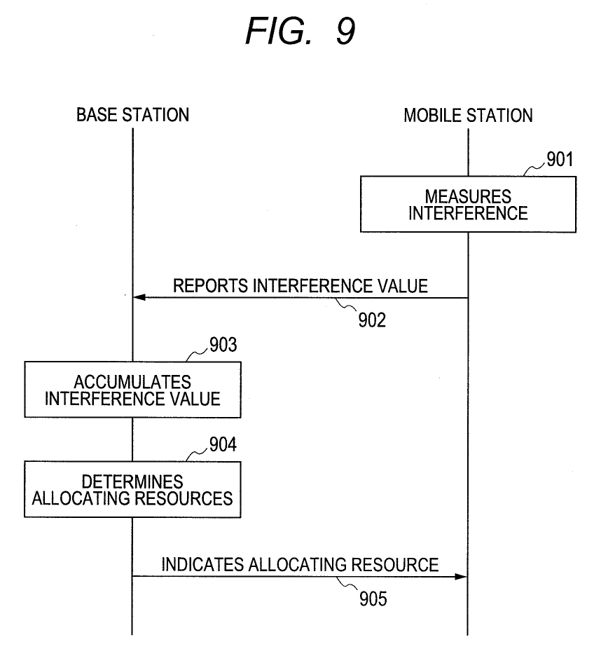

A sequence diagram of scheduling that is performed by the scheduling unit 703 is shown in FIG. 9.

First, at step 901, each mobile station measures interference values on resources to measure reception quality. Here, as an interference metric value, CINR (Carrier to Interference plus noise ratio), interference power, etc. may be used. Hereinafter, CINR is assumed as an example of an interference metric value. Measured CINR values are averaged in frequency and time domains. Units of averaging them in the frequency domain are a whole bandwidth and sub-bandwidths into which the whole bandwidth is divided. If measured CINR values are averaged over the whole bandwidth, the amount of information when CINR is reported is reduced, but precision deteriorates. On the other hand, if measured CINR values are averaged over each of the sub-bandwidths, the amount of information when CINR is reported is increased, but precision is better. As for averaging measured CINR values in the time domain, an averaging method per time window as expressed by Equation 1 and an averaging method using a forgetting factor as expressed by Equation 2 are possible. In the following Equations 1 and 2, γₐᵥₑ (t) is averaged CINR over a frame numbered T is a time window (in frame units) over which averaging is done, γ (i) is frequency-averaged CINR over a frame numbered i, and λ is a forgetting factor (0<λ≦1). When the forgetting factor λ is set smaller, measured CINR values are averaged with earlier CINR values being more weighted. When the forgetting factor λ is set larger, measured CINR values are averaged with later CINR values being more weighted. However, methods of averaging interference values are not limited to those mentioned above. Any method enabling averaging interference values in both frequency and time domains may be used nonlimitingly.

$$\begin{matrix}{\overline{γ}}_{ave} ( t ) = \frac{1}{T} {\sum }_{i = t - T}^{t - 1} γ ( i ) & [ Equation 1 ] \\ {\overline{γ}}_{ave} ( t ) = ( 1 - λ ) {\overline{γ}}_{ave} ( t ) + λγ ( t - 1 ) & [ Equation 2 ]\end{matrix}$$

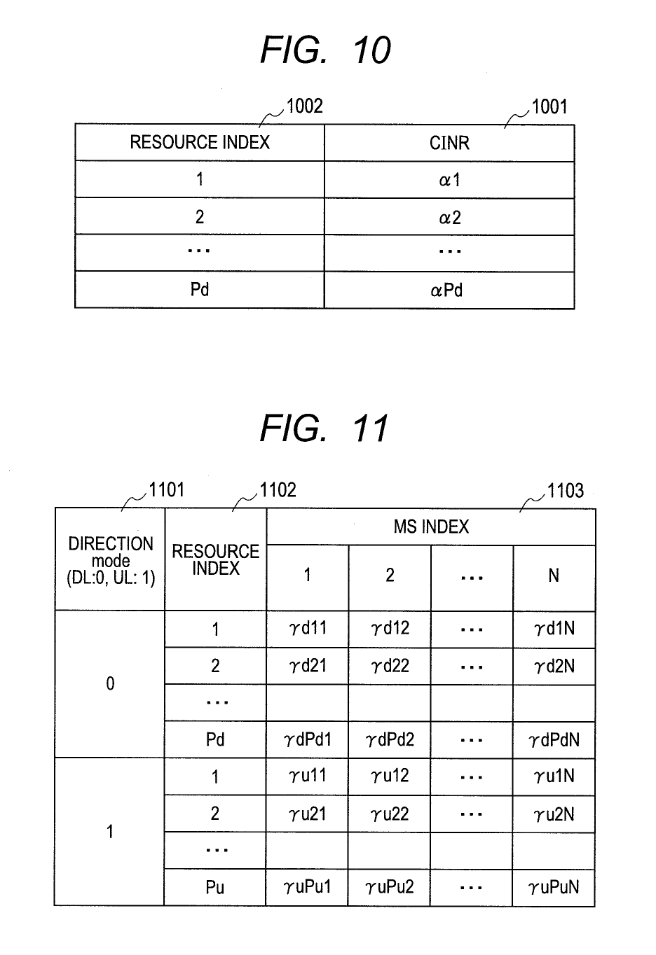

Next, at step 902, the mobile station reports interference values measured at step 901 to the base station. Reporting interference values on downlink is performed such that each mobile station reports to the base station CINR 1001 on each of resources having respective unique resource indices 1002, using a table as shown in FIG. 10. Interference values on uplink are measured such that each mobile station transmits a reference signal to the base station and the base station measures CINR or the base station measures CINR periodically. To report interference values, a resource for reporting which has been preconfigured by the base station is used. Alternatively, interference values may be reported using a resource allocated to each mobile station individually, though it is not dedicated to reporting. Interference values may be reported by request from the base station or periodically at a predetermined interval.

At step 903, the base station accumulates interference values reported from each mobile station and creates a table holding CINR values for each resource for each mobile station.

At step 904, the base station decides resource allocations to each mobile station using CINRs reported from mobile stations and accumulated in the table at step 903. At step 905, the base station notifies allocated resources to each mobile station by the transmitter and receiver 3703. The mobile station receives by the antenna 809 information for a result of resource allocation from the base station and will transmit and receive data to/from the base station using the allocated resources. The mobile station will be transmitting and receiving data with the operations of software shown in FIG. 8 and hardware shown in FIG. 39 previously described with regard to uplink and downlink. To notify resource allocations, a resource for notification which has been preconfigured by the base station is used. Alternatively, resource allocations may be notified using a resource allocated to each mobile station individually, though it is not for notification.

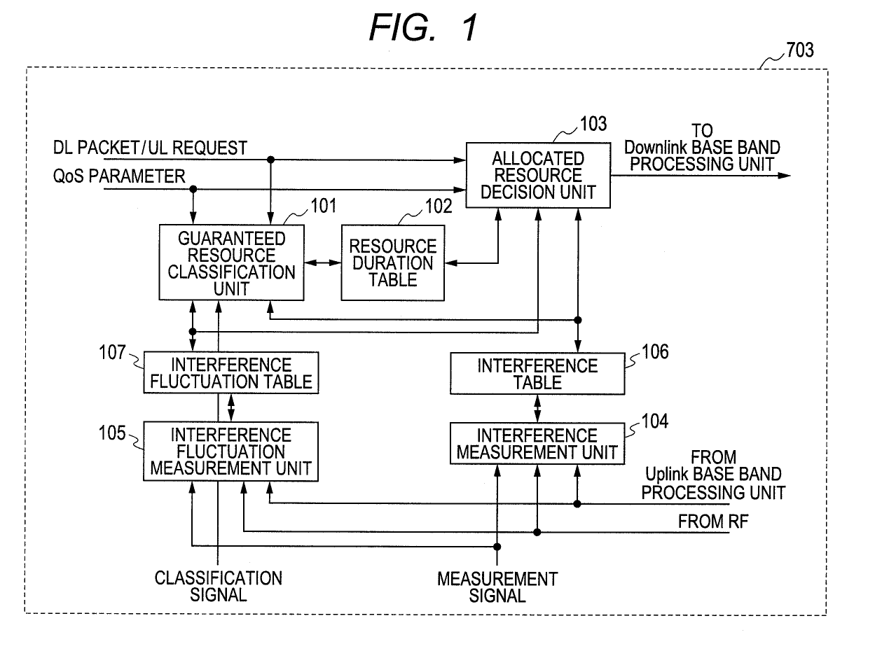

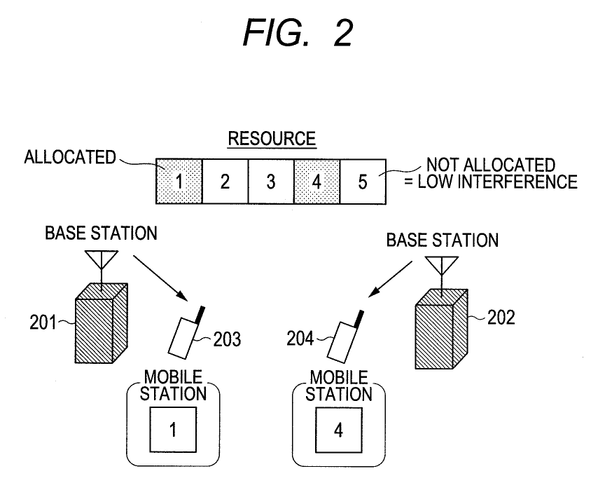

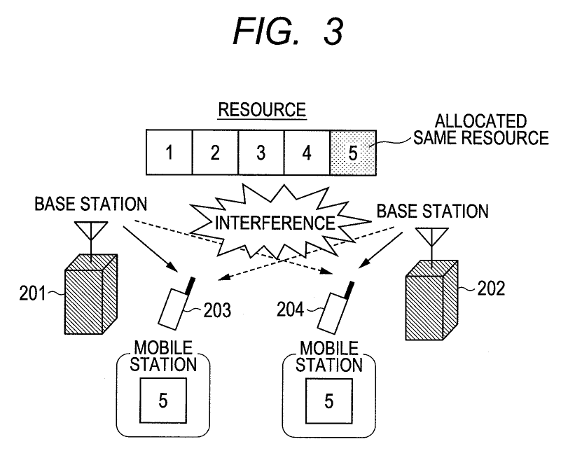

The scheduling unit 703 of a base station relevant to the present embodiment described with regard to FIG. 7 is constructed as is shown in FIG. 1. The scheduling unit 703 comprises an interference measurement unit 104 which measures interference on each resource from received signal RF (in the case of scheduling on uplink) or a base band processed signal (in the case of scheduling on downlink), a interference fluctuation measurement unit 105 which measures a degree of fluctuation in interference on each resource, a guaranteed resource classification unit 101 which decides resources to be allocated for a long duration to guarantee a transmission rate based on a QoS parameter of a minimum sustained rate, referring to an interference table 106 which holds interference values on the respective resource resulting from measurement performed by the interference measurement unit 104 and an interference fluctuation table 107 which holds interference fluctuation values on the respective resources resulting from measurement performed by the interference fluctuation measurement unit 105, triggered by a packet arrival in the case of downlink or by a communication request from a mobile station in the case of uplink, and an allocated resource decision unit 103 which decides resources to be used for communication with a mobile station, referring to an allocating duration table 102 which holds a duration of allocation of each resource classified by the guaranteed resource classification unit 101, the interference table 106, and the interference fluctuation table. The allocated resource decision unit 103 may determine resources to be used for communication with a mobile station, referring to only the allocating duration table 102. The guaranteed resource classification unit 101 regards resources having a small fluctuation in interference and expected to continue to be allocated for a longer duration as guaranteed resources. The interference table 106 resides within the data memory 3706 in FIG. 37 and holds measured interference values for each resource for each mobile station. The interference fluctuation table 107 resides within the data memory 3706 in FIG. 37 and holds interference fluctuation values for each resource for each mobile station. The allocating duration table 102 resides within the data memory 3706 in FIG. 37 and holds how long allocation continues for each resource allocated to each mobile station. Further, the allocated resource decision unit 103 allocates guaranteed resources for resource allocation yielding up to the minimum sustained rate, referring to the allocating duration table 102, and updates the allocating duration table 102 so that allocations of guaranteed resources will continue longer that allocations of resources yielding more than the minimum sustained rate. Here, a value of a minimum sustained rate included in a QoS parameter per mobile station is stored in a QoS table, as is shown in FIG. 43, which resides within the data memory 3706 in FIG. 37.

The interference table 106 is shown in FIG. 11. A column 1101 represents a direction. For downlink CINR, that is, CINR of a signal received at a mobile station, mode=0 is set. For uplink CINR, that is, CINR of a signal received at a base station, mode=1 is set. A column 1102 represents a resource index and a column 1103 represents a mobile station index (hereinafter called as an MS index). The interference table 106 holds interference values γdpn, γupn, where p is a resource index and n is a MS index, for downlink and uplink resources for each mobile station. Here, if an average of interference values measured for a plurality of resources is used, the amount of memory for the interference table can be reduced, although precision deteriorates. For example, if each mobile station measures an average CINR for an L number of resources on downlink at step 901 in FIG. 9 and reports it to the base station at step 902, the number of records for downlink in the column 1102 in FIG. 11, i.e., the amount of memory required to store them is reduced to 1/L. The same applies to a case where, at the base station, averaging interferences measured for an L number of resources is performed.

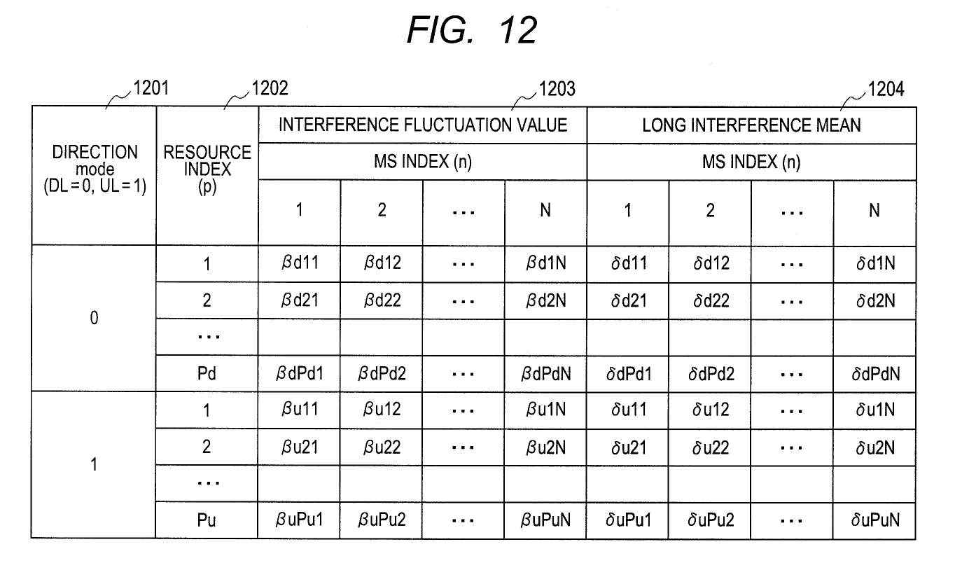

The interference fluctuation table 107 is shown in FIG. 12. A column 1201 represents a direction. For downlink CINR fluctuation, that is, fluctuation of CINR of a signal received at a mobile station, mode=0 is set. For uplink CINR fluctuation, that is, fluctuation of CINR of a signal received at a base station, mode=1 is set. A column 1202 represents a resource index and a column 1203 represents a MS index. The interference fluctuation table 107 holds interference fluctuation values βdpn, βupn for downlink and uplink resources for each mobile station. The table also holds average CINR values for a long period δdpn, δupn to obtain fluctuation values. Here, p is a resource index and n is a MS index. Here, if an average of interference values measured for a plurality of resources is used, the amount of memory for the interference fluctuation table can be reduced, although precision deteriorates. For example, if each mobile station measures an average CINR for an L number of resources on downlink at step 901 in FIG. 9 and reports it to the base station at step 902, the number of records for downlink in the column 1202 in FIG. 12, i.e., the amount of memory required to store them is reduced to 1/L. The same applies to a case where, at the base station, averaging interferences measured for an L number of resources is performed.

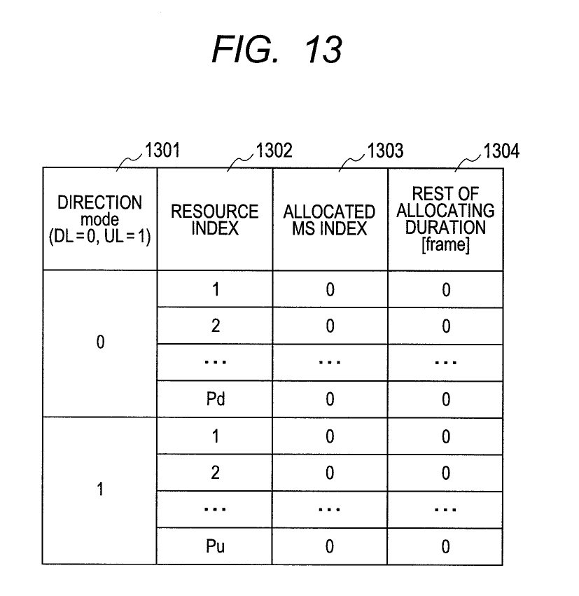

The allocating duration table 102 is shown in FIG. 13. A column 1301 represents a direction. For downlink resource allocation, mode=0 is set. For uplink resource allocation, mode=1 is set. A column 1302 represents a resource index. A column 1303 represents a MS index to which each resource is allocated. Since no resource is allocated to a mobile station in an initial state, a value indicating no allocation, e.g., 0, FF, etc. is set in this column. A column 1304 represents the rest of allocating duration of the resource allocated to each mobile station. Duration is specified in units of frames; however, there is no limitation to this. Duration may be specified in any time units indicating timing at which the resource becomes reallocable. A resource for which the rest of allocating duration has become 0 can be reallocated. A resource for which the rest of allocating duration is 1 or more remains in the previously allocated state without being reallocated. FIG. 38 shows an example of this table where resources are allocated to mobile stations. Downlink resources indexed 1 and Pd are allocated to a MS index 3 and their allocations remain unchanged on account of their rest of allocating duration=2. However, a resource index 2 is allocated to a MS index 1 and this resource is reallocable on account of its rest of allocating duration=0. Here, if a block of a plurality of resources is allocated, the amount of memory for the allocating duration table 102 can be reduced. For example, if a block of an L number of downlink resources is allocated, the number of records for downlink in the column 1302 in FIG. 13, i.e., the amount of memory required to store them is reduced to 1/L. The same applies to a case where a block of an L number of uplink resources is allocated.

The interference measurement unit 104 and the interference fluctuation measurement unit 105 operate by receiving a measurement signal from the controller 710, instructing to update the interference table 106 and the interference fluctuation table 107. The guaranteed resource classification unit 101 receives from the controller 710 a signal to update the rest of allocating duration 1304 (FIG. 13) in the allocating duration table 102 and decides resources for which longer duration of allocation should be set. The allocated resource decision unit 103, upon a packet arrival in the case of downlink or receiving a communication request from a mobile station in the case of uplink, decides resources allocated to the mobile station and updates the MS index to which resource is allocated 1303 and the rest of allocating duration 1304 (FIG. 13) in the allocating duration table 102. Here, the above operations are the same for downlink and uplink, except that CINRs to be input to the interference measurement unit 104 and the interference fluctuation measurement unit 105 differ, i.e., CINRs reported from mobile stations and CINRs measured at a base station. Hence, the operations for downlink will be described hereinafter by way of example with the understanding that the same operations are performed for uplink. It is assumed that mobile stations report CINRs of respective resources individually. That is, mobile stations report CINRs on all of a Pd number of resources. In a case where CINRs of L resources are reported in a batch, the resource index column may contain resources of 1 to Pd divided by L.

The present embodiment is characterized as follows. According to interference measurement results reported from mobile stations, resources having a small fluctuation in interference are classified as guaranteed resources. Guaranteed resources are allocated up to satisfying a minimum sustained rate so as to continue their allocations for a longer duration. At the same time, non-guaranteed resources are allocated for a shorter duration for a service that should be provided at a rate more than the minimum sustained rate.

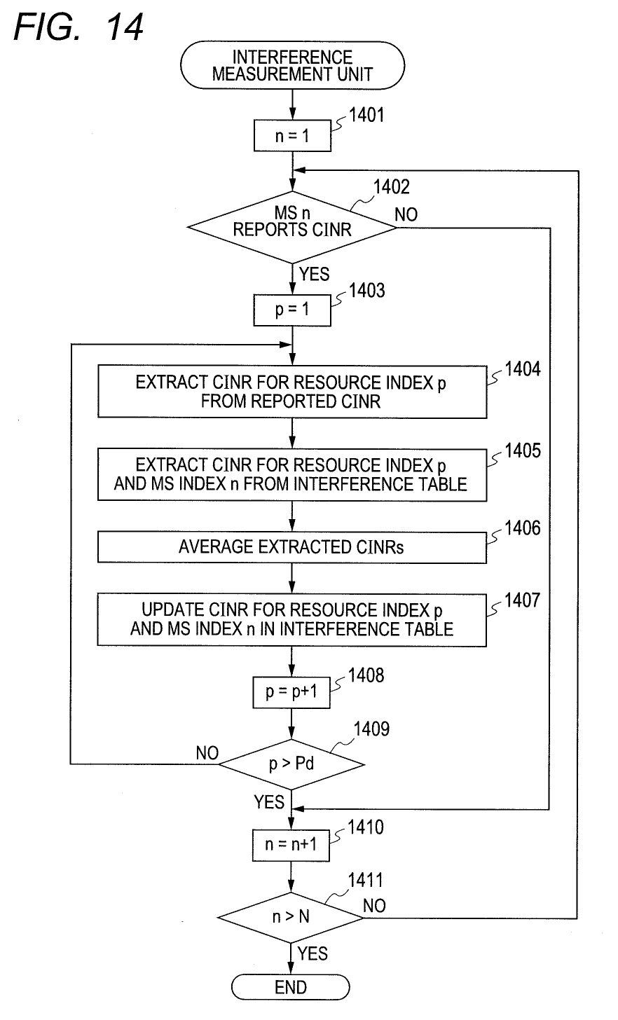

The interference measurement unit 104 looks for which mobile station is reporting CINRs, calculates and outputs a time average of CINRs for each resource reported from the mobile station as an interference measurement result, and updates the interference table 106. A flowchart hereof is shown in FIG. 14.

At step 1401, the unit initializes the MS index to look for to n=1 in order to look for a mobile station reporting CINRs.

At step 1402, if a MS index n is reporting CINRs, the unit goes to step 1403.

At step 1403, the unit initializes the resource index to p=1 in order to update the interference value for each resource.

At step 1404, the unit extracts CINR αp corresponding to an interference value on a resource index p from the reported CINR list shown in FIG. 10 from the MS index n.

At step 1405, the unit extracts CINR γdpn corresponding to an interference value associated with the MS index n and the resource index p from the interference table 106 shown in FIG. 11.

At step 1406, the unit calculates a time average CINR using the CINRs extracted at steps 1404 and 1405, e.g., according to Equation 3, and goes to step 1407. In the following equation, λ is a forgetting factor.

γ_{dpn}=(1−λ)γ_{dpn}+λαₚ [Equation 3]

At step 1407, the unit updates the above value of ydpn in the interference table 106 shown in FIG. 11 and goes to step 1408.

At step 1408, the unit increments the resource index to update.

At step 1409, if p>Pd, the unit decides that updating all resources is complete and goes to step 1410. If p≦Pd, the unit decides that updating all resources is not complete and returns to step 1404.

At step 1410, the unit increments the MS index to look for.

At step 1411, if n>N, the unit decides that looking for all mobile stations is complete and terminates the processing. If n≦N, the unit decides that looking for all mobile stations is not complete and returns to step 1402.

If the MS index n is not reporting CINRs at step 1402, the unit goes to step 1410 without updating the CINR on the resource.

Time averaging of CINRs at step 1406 may be done in accordance with any other formula not limited to Equation 3. It is also possible to output reported CINRs simply as interference measurement results without averaging the CINRs. In that case, steps 1405 and 1406 are not operative.

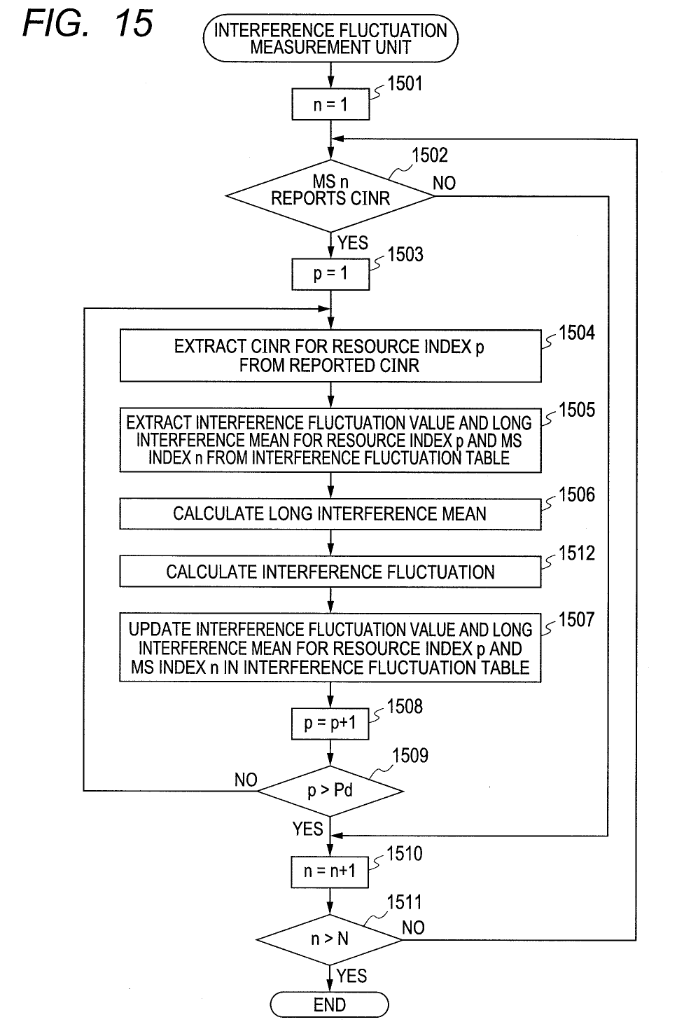

The interference fluctuation measurement unit 105 looks for which mobile station is reporting CINRs, calculates a CINR fluctuation value from CINRs for each resource reported from the mobile station, and updates the interference fluctuation table 107. A flowchart hereof is shown in FIG. 15.

At step 1501, the unit initializes the MS index to look for to n=1 in order to look for a mobile station reporting CINRs.

At step 1502, if a MS index n is reporting CINRs, the unit goes to step 1503.

At step 1503, the unit initializes the resource index to p=1 in order to update the interference fluctuation value for each resource.

At step 1504, the unit extracts CINR αp corresponding to an interference value on a resource index p from the reported CINR list shown in FIG. 10 from the MS index n.

At step 1505, the unit extracts an interference fluctuation value βdpn and an long interference mean δdpn associated with the MS index n and the resource index p from the interference fluctuation table shown in FIG. 12.

At step 1506, the unit calculates a time average CINR using the CINR αp extracted at step 1504 and the long interference mean δdpn, e.g., according to Equation 4, updates the long interference mean δdpn, and goes to step 1512. In the following equation, λ1 is a forgetting factor, the previous long interference mean is denoted by δdpn (t−1), and the updated long interference mean is denoted by δdpn (t). Preferably, the previous long interference mean is more weighted, because δdpn is used to calculate an interference fluctuation value βdpn. That is, λ1 should be set to a value approximate to 0, e.g., λ1=0.01.

δ_{dpn}(t)=(1−λ₁)δ_{dpn}(t−1)+λ₁αₚ [Equation 4]

At step 1512, the unit updates the interference fluctuation value βdpn using the CINR αp extracted at step 1504, the interference fluctuation value βdpn extracted at step 1505, and the long interference mean δdpn(t) updated at step 1506, e.g., according to Equation 5. In the following equation, λ2 is a forgetting factor, the previous interference fluctuation value is denoted by βdpn(t−1), and the updated interference fluctuation value is denoted by βdpn(t).

β_{dpn}(t)=(1−λ₂)β_{dpn}(t−1)+λ₂(αₚ−δ_{dpn}(t))² [Equation 5]

At step 1507, the unit updates the above values of βdpn and δdpn in the interference table 106 and goes to step 1508.

At step 1508, the unit increments the resource index to update.

At step 1509, if p>Pd, the unit decides that updating all resources is complete and goes to step 1510. If p≦Pd, the unit decides that updating all resources is not complete and returns to step 1504.

At step 1510, the unit increments the MS index to look for.

At step 1511, if n>N, the unit decides that looking for all mobile stations is complete and terminates the processing. If n≦N, the unit decides that looking for all mobile stations is not complete and returns to step 1502.

If the MS index n is not reporting CINRs at step 1502, the unit goes to step 1510 without updating the CINR on the resource.

Time averaging of CINRs at step 1506 may be done in accordance with any other formula not limited to Equation 4.

Measuring interference fluctuation at step 1512 may be done in accordance with any other formula not limited to Equation 5.

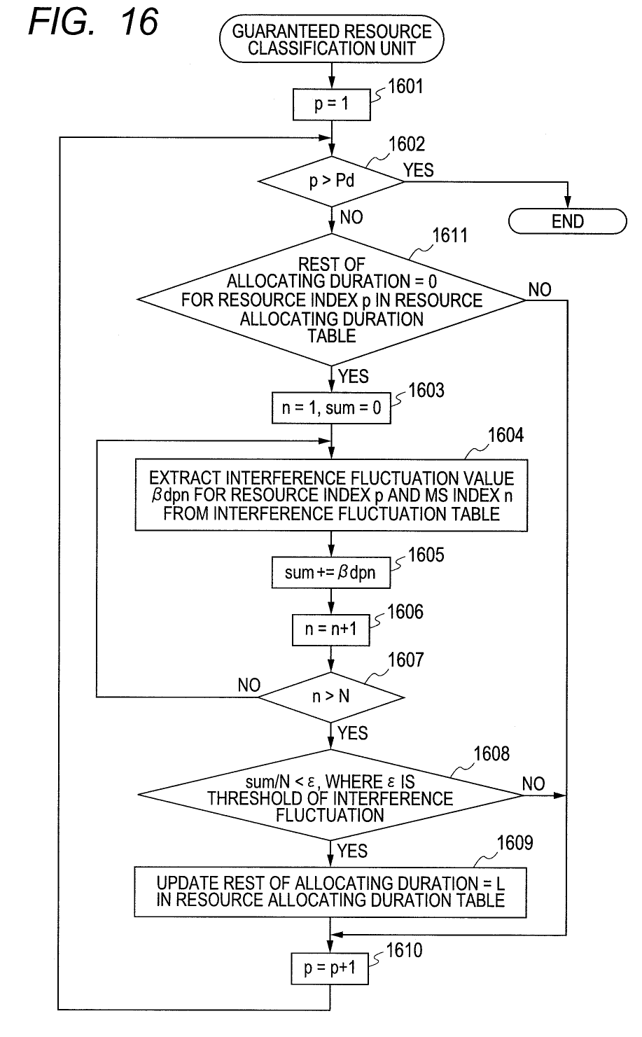

Next, operations of the guaranteed resource classification unit 101 are described below. The guaranteed resource classification unit 101 refers to the interference fluctuation table 107 and classifies resources having a small interference fluctuation value from among resources with the rest of allocating duration=0 in the allocating duration table 102 in FIG. 13 as guaranteed resources. The unit updates the rest of allocating duration 1304 for such resources to a value of L, where L is an integer equal to or more than 1 and larger than duration of allocation M for non-guaranteed resources, and L can be set to an arbitrary value. In classifying guaranteed resources, the unit judges a resource as guaranteed type depending on whether an average of the interference fluctuation values on the resource evaluated for the respective mobile stations is less than a threshold value. Guaranteed resources experience less varying interference, so they can provide a stable transmission rate when allocated to a mobile station. A flowchart of classifying guaranteed resources is shown in FIG. 16.

At step 1601, the unit initializes the resource index for which the unit should decide whether to classify it as guaranteed resources.

At step 1602, if not p>Pd, i.e., it is determined that classifying all resources is not complete, the unit goes to step 1611.

At step 1611, if the rest of allocating duration is 0 for a resource index p in the allocating duration table 102, the unit goes to step 1603.

At step 1603, the unit initializes the MS index for which its interference fluctuation value should be checked and initializes sum=0 to calculate an average interference fluctuation value.

At step 1604, the unit extracts an interference fluctuation value βdpn associated with a MS index n and a resource index p from the interference fluctuation table 107 shown in FIG. 12 and goes to step 1605.

At step 1605, the unit calculates sum+=βdpn.

At step 1606, the unit increments the MS index.

At step 1607, if not n>N, i.e., it is determined that checking the interference fluctuation values evaluated for all mobile stations is not complete, the unit returns to step 1604. If n>N, i.e., it is determined that checking the interference fluctuation values evaluated for all mobile stations is complete, the unit goes to step 1608.

At step 1608, if it is determined that an average sum/N of the interference fluctuation values is less than a threshold value ε, the unit judges the resource as guaranteed type and goes to step 1609. If the average sum/N of the interference fluctuation values is not less than threshold value ε, the unit judges the resource as non-guaranteed type and goes to step 1610. Here, the threshold value ε may be initially set or may be configured from a network entity, e.g., GW 402 as shown in FIG. 4 and held on the data memory 3706 of the base station. A method of setting ε is as follows. For example, as is illustrated in FIG. 48, in a case where an MCS (Modulation and Coding Scheme) out of possible MCSs as listed in FIG. 47 is selected based on an interference value 4800 and data is transmitted to a mobile station, ε should be set so that interference fluctuation does not exceed a width between thresholds 4801 for selecting each MCS. For example, if the width between thresholds 4801 for selecting each MCS is set at 3 dB, the threshold value E should be set as ε=2 dB<3 dB. A method of setting a holding the threshold value ε is not limited to the foregoing.

At step 1609, the unit updates the rest of allocating duration 1304 for the resource to L in the allocating duration table 102, sorts the resource as guaranteed type, and goes to step 1610. Here, the rest of allocating duration L may be initially set or may be configured from a network entity, e.g., GW 402 as shown in FIG. 4 and held on the data memory 3706 of the base station. L is the duration of allocation of guaranteed resources and has to be set longer than the duration of allocation of non-guaranteed resources. If L is set relatively short, resource allocation may easily follow bearer change due to mobile station mobility, whereas the effect of suppressing fluctuation in interference with other base stations is lowered. If L is set relatively long, the effect of suppressing fluctuation in interference with other base stations is enhanced, whereas resource allocation may not easily follow bearer change due to mobile station mobility. For example, on base stations deployed in areas, e.g., along a highway and a railroad, where mobile stations are assumed to move fast, L should be set relatively short. On base stations deployed in areas, e.g., in cities, where mobile stations are assumed to move slow, L should be set relatively long.

At step 1611, if the rest of allocating duration 1304 is not 0 for a resource index p in the allocating duration table 102, the unit goes to step 1610.

At step 1610, the unit increments the resource index and returns to step 1602.

At step 1602, if p>Pd, i.e., classifying all resources is complete, the unit terminates the processing.

The flowchart of FIG. 16 is not limited to the foregoing and its variants are possible, provided that the process includes calculating an average of interference fluctuation values for a resource, comparing it to the threshold value, and classifying the resource as guaranteed type if the average is less than the threshold value.

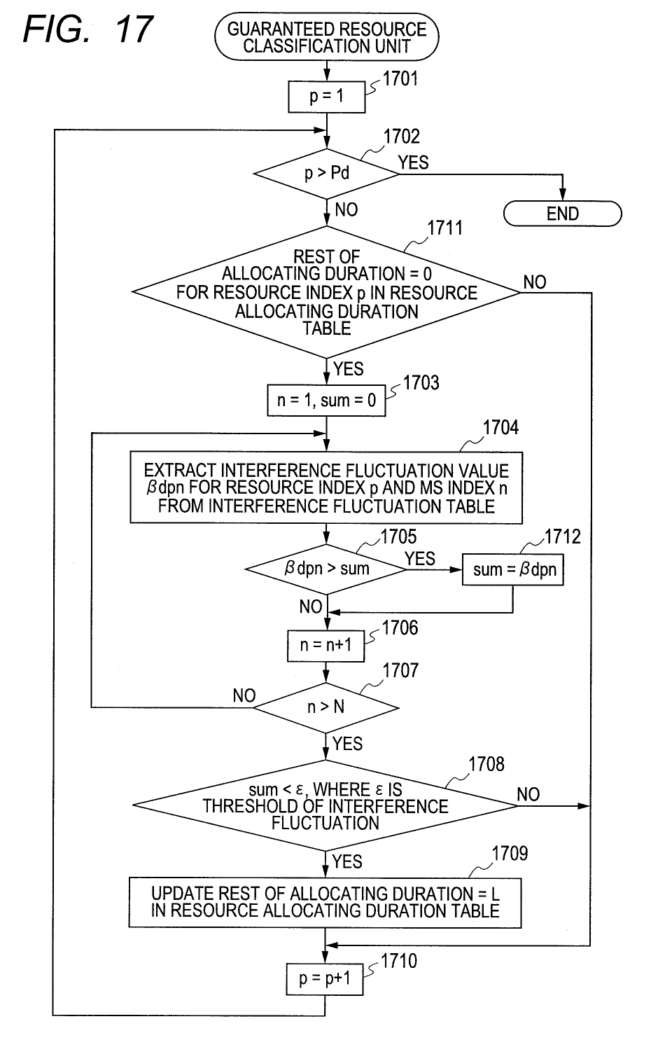

Although an average is used as an interference fluctuation value for comparison to the threshold value, there is no limitation to this and an alternative is possible, provide that it represents a degree of fluctuation in interference on resources. For example, a value representing a maximum interference fluctuation value for the resource among the respective users may be compared to the threshold value. To illustrate operations of the guaranteed resource classification unit 101 in this case, the flowchart is shown in FIG. 17.

Unlike FIG. 16, the unit operates to assign a maximum interference fluctuation value to sum at step 1705 and step 1712 and compares sum, the maximum interference fluctuation value to the threshold value E at step 1708.

To classify guaranteed resources, it is also possible to use average interference values for a long period besides interference fluctuation values. In this case, with regard to resources judged as guaranteed type, for a resource whose interference value for a long period is less than the threshold value ε, that is, whose average CINR for a long period is less than the threshold value c, experiencing a large interference continuously, the unit does not sort it as guaranteed type. Thereby, it is possible to prevent allocating resources with deteriorated CINR, although conditional branching increases.

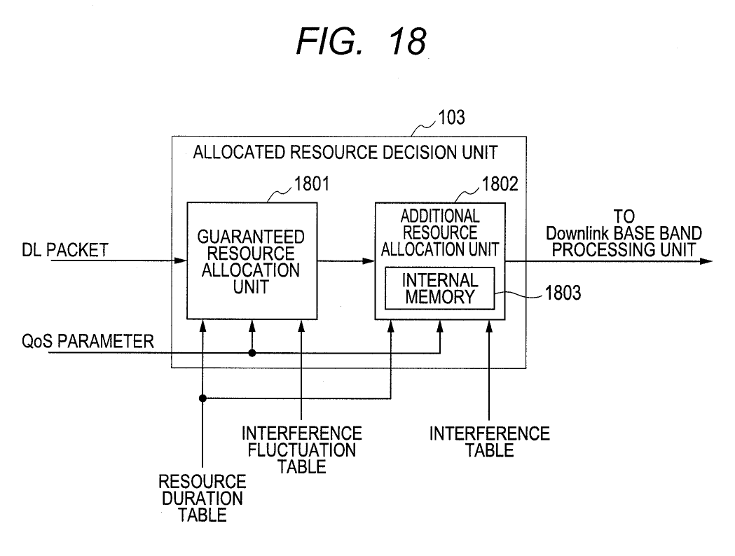

The allocated resource decision unit 103 is depicted in a block diagram as shown in FIG. 18. A guaranteed allocation unit 1801 extracts a minimum sustained rate to be guaranteed from a downlink QoS parameter. For resource allocation yielding up to the minimum sustained rate, guaranteed resources having a long duration of allocation are preferentially allocated. An additional allocation unit 1802 has an inner memory 4803 in order to calculate a cost function by which respective resources are prioritized for each mobile station. Referring to the cost function values, the unit allocates non-guaranteed resources for resource allocation yielding more than the minimum sustained rate and sets their duration of allocation shorter. Since guaranteed resources are resources suitable for achieving a stable transmission rate, they are capable of guaranteeing a minimum sustained rate. Meanwhile, by providing flexibility for allocating non-guaranteed resources without only using guaranteed resources, it is possible to handle a service at a high transmission rate by additional allocation.

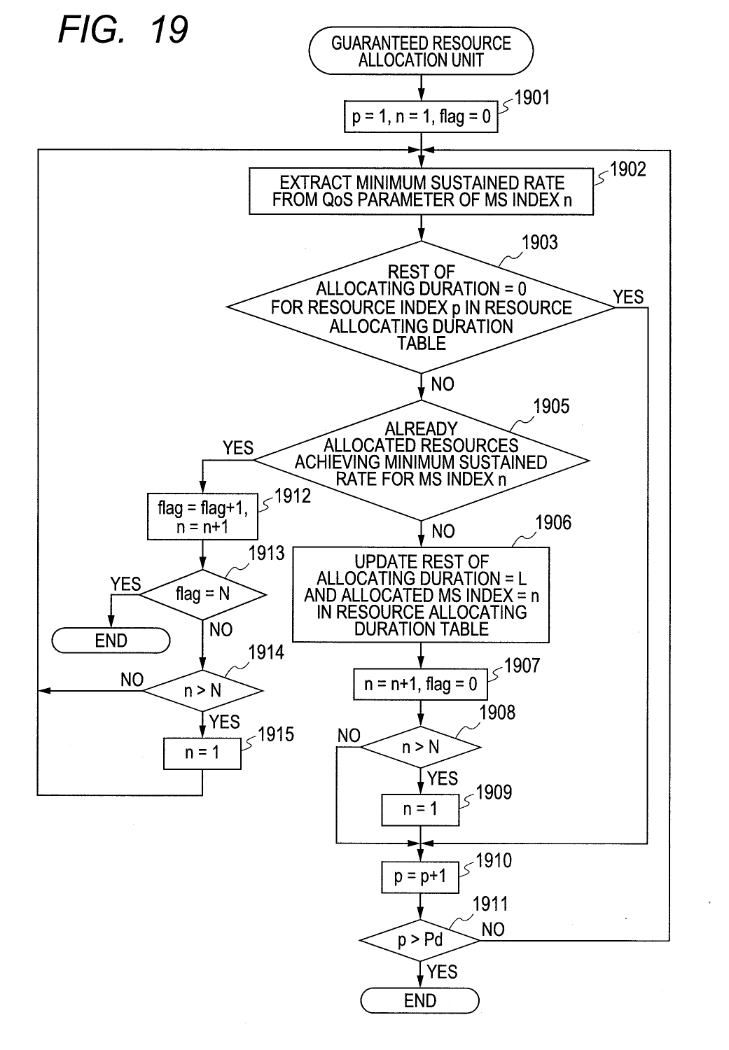

A flowchart of the guaranteed allocation unit 1801 is shown in FIG. 19.

At step 1901, the unit initializes the resource index to p=1 and the MS index to n=1 in order to retrieve guaranteed resources in order and initializes a flag indicating that allocation yielding up to a minimum sustained rate is complete to flag=0.

At 1902, the unit extracts a minimum sustained rate to be guaranteed from a QoS parameter for a MS index n.

At 1903, the unit refers to the allocating duration table 102 shown in FIG. 13 and, if the rest of allocating duration 1304 for a resource index p is not 0, that is, this resource is guaranteed type, the unit goes to step 1905. At this step, the unit determines whether or not resource allocation yielding up to the minimum sustained rate to the MS index n is complete. Here, a flowchart for decision at step 1905 is shown in FIG. 45.

At step 4501, the unit extracts the minimum sustained rate 4302 to be guaranteed for the MS index n 4301 from the QoS table in FIG. 43 and calculates data amount D [bits] to be transmitted at the current allocation timing. For example, if resource allocations to mobile stations are performed at an interval of 5 ms and resources for 5 ms are allocated at the current allocation timing, given the minimum sustained rate of 500 kbps, data amount D to be transmitted at the current allocation timing to satisfy the minimum sustained rate is calculated as: D=500[kbps]*0.005[s]=2.5 kbits.

At step 4502, the unit refers to the allocating duration table 102 illustrated in FIG. 13 and calculates data amount L [bits] that can be transmitted by resources allocated to the MS index n. The base station has an MCS Index table as shown in FIG. 46 holding indexes of a table holding MCSs (Modulation and Coding Schemes), i.e., modulation schemes which are used for transmission to/from each mobile station. The guaranteed allocation unit extracts an MCS index associated with the mobile station from the table, extracts an MCS corresponding to the MCS index from the table in FIG. 47, and calculates the data amount L that can be transmitted by the resources allocated to the mobile station based on the MCS. For example, the MCS for a MS index 2 is ½-16QAM according to FIG. 46 and FIG. 47. ½-16QAM means that 4*½=2 bits can be transmitted per simple. If 48 symbols can be transmitted per resource and 20 resources are allocated to the MS index 2, L is calculated as: L=2*48*20=1.92 kbits. MCSs listed in FIG. 47 are only exemplary and other modulation schemes can also be applied to the present embodiment.

At step 4503, if D≦L, that is, it is determined that the data amount to be transmitted at the current allocation timing is larger than the data amount required to satisfy the minimum sustained rate, the unit goes to step 4504. If D>L, that is, it is determined that the data amount to be transmitted at the current allocation timing is smaller than the data amount required to satisfy the minimum sustained rate, the unit goes to step 4505.

At step 4504, the unit decides that allocation yielding up to the minimum sustained rate is complete and terminates the processing.

At step 4505, the unit decides that allocation yielding up to the minimum sustained rate is not complete and terminates the processing.

If it is decided that resource allocation yielding up to the minimum sustained rate to the MS index n is complete at step 1905, the unit goes to step 1912.

At step 1912, the unit increments the flag and the MS index and goes to step 1913.

At step 1913, if flag=N, that is, allocation yielding up to the minimum sustained rate is complete for all mobile stations, the unit terminates the processing. If flag<N, that is, allocation yielding up to the minimum sustained rate is not complete for all mobile stations, the unit goes to step 1914. At step 1914, if it is determined that n≦N, the unit returns to step 1902. If it is determined that n>N, the unit goes to step 1915.

At step 1915. the unit initializes the MS index to n=1 and returns to step 1902.

However, if it is decided that resource allocation yielding up to the minimum sustained rate to the MS index n is not complete at step 1905, the unit goes to step 1906. At step 1906, the unit updates the MS index to which the resource index p is allocated to n in the column 1303 of MS index to which resource is allocated in the allocating duration table 102 illustrated in FIG. 13, allocates the resource index p to the MS index n, sets the rest of allocating duration to L, and goes to step 1907.

At step 1907, the unit increments the MS index, initializes the flag, and goes to step 1908.

At step 1908, if it is determined that n>N, the unit goes to step 1909. If it is determined that n≦N, the unit goes to step 1910.

At step 1909, the unit initializes the MS index to n=1 and goes to step 1910.

At step 1903, the unit refers to the allocating duration table 102 and, if the rest of allocating duration 1304=0 for the resource index p, that is, the resource is not guaranteed type, the unit goes to step 1910.

At step 1910, the unit increments the resource index and goes to step 1911.

At step 1911, if p Pd, that is, retrieving all resources is not complete, the unit returns to step 1902. If p>Pd, that is, retrieving all resources is complete, the unit terminates the processing.

The flowchart of FIG. 19 is not limited to the foregoing and its variants are possible, provided that the process includes allocating guaranteed resources sequentially to mobile stations for which allocated resources do not satisfy the minimum sustained rate and updating the duration of allocation of the resources to L (L>1).

The flowchart of FIG. 19 is used to allocate guaranteed resources classified on the basis of the threshold value ε of interference fluctuation, thus yielding up to the minimum sustained rate. Here, the threshold value ε may be modified depending on whether guaranteed resources are sufficient for allocation yielding up to the minimum sustained rate. Specifically, if guaranteed resources are insufficient, it is possible to increase guaranteed resources by making the threshold value ε larger, although interference fluctuation becomes slightly larger. On the other hand, if guaranteed resources are excessive, it is possible to lessen interference fluctuation by making the threshold value ε smaller, although guaranteed resources decrease. For modifying the threshold value ε, a flowchart added to the flowchart of FIG. 19 is shown in FIG. 49.

The flowchart of FIG. 49 is inserted after step 1911 in the flowchart of FIG. 19.

At step 4901, the guaranteed allocation unit initializes the MS index to n=1 and temp=0 in order to count the number of mobile stations for which resources yielding up to the minimum sustained rate are allocated.

At step 4902, the unit checks whether or not resources yielding up to the minimum sustained rate have been allocated to the MS index n, similarly to step 1905. If resources yielding up to the minimum sustained rate have been allocated, the unit goes to step 4903; if not, the unit goes to step 4904.

At step 4903, the unit increments tmp.

At step 4904, the unit increments the MS index.

At step 4905, if n≦N, that is, retrieving all mobile stations is not complete, the unit returns to step 4902. If n>N, that is, retrieving all mobile stations is complete, the unit goes to step 4906.

At step 4906, if not tmp=N, that is, resources yielding up to the minimum sustained rate are not allocated to all mobile stations, the unit goes to step 4907. If tmp=N, that is, resources yielding up to the minimum sustained rate are allocated to all mobile stations, the unit goes to step 4908.

At step 4907, the unit sets ε+=δ to increase the threshold value ε of interference fluctuation and terminates the processing. Here, a value of δ may be initially set or may be configured from a network entity, e.g., GW 402 and held on the data memory 3706 of the base station.

At step 4908, the unit sets ε−=δ to decrease the threshold value ε of interference fluctuation, terminates the processing to update the threshold value 4909, and returns to step 1911.

The guaranteed allocation unit 1801 may allocate a variable number of guaranteed resources to each mobile station according to interference and interference fluctuation values for each mobile station, instead of evenly allocating guaranteed resources to the respective mobile stations as illustrated in FIG. 19

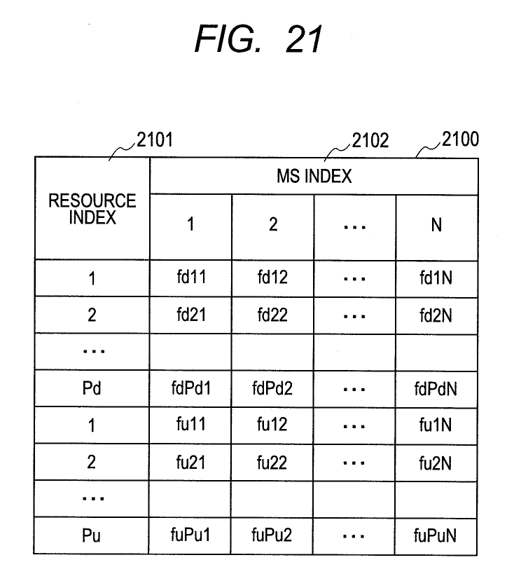

In the additional allocation unit 1802, the inner memory 1803 resides to store cost function values for the pairs of resource indices and MS indices. This unit has a cost function table 2100 as shown in FIG. 21. A column 2101 represents a resource index, a column 2102 represents a MS index, and calculated cost function values are stored in this table. A flowchart of the additional allocation unit 1802 is shown in FIG. 20.

At step 2001, the unit initializes the resource index to p=1 and all cost function values to −1.

At step 2002, if the MS index to which resource is allocated=0 in the allocating duration table 102 shown in FIG. 13, that is, the resource is not allocated, the unit goes to step 2003.

At step 2003, the unit refers to the interference table 106 shown in FIG. 11, extracts CINRγ, and calculates cost function values fₚₙ of all mobile stations (where MS index is n) for the resource index p. For example, the cost function is calculated by the following equation.

$${f}_{pn} = \frac{{r}_{pn}}{{R}_{n} ( t )} , {r}_{pn} = {log}_{2} ( 1 + {γ}_{pn} ) \qquad [ Equation 6 ]$$

Here, Rn(t)=Rn(t−1)+rpn, where Rn(t) is an average transmission rate until the current allocation timing, Rn(t−1) is an average transmission rate until the previous allocation timing. rpn is a transmission rate in a moment, obtained from CINR by Equation 6.

At step 2004, if p≦Pd, that is, calculating the cost function for all resources is not complete, the unit goes to step 2005.

At step 2002, if not the MS index to which resource is allocated=0 in the allocating duration table 102 shown in FIG. 13, that is, the resource has already been allocated, the unit goes to step 2005.

At step 2005, the unit increments the resource index and returns to step 2002.

At step 2004, if p>Pd, that is, calculating the cost function for all resources is complete, the unit goes to step 2006.

At step 2006, the unit extracts a pair of a resource index p and a MS index n, the pair having the largest value of cost function, provide that the resource index p is a resource for which the rest of allocating duration 1304=0, that is, non-guaranteed resource not allocated.

At step 2007, if allocation to the MS index n is not complete, the unit goes to step 2008.

At step 2008, the unit updates the MS index to which the resource index p is allocated to n in the column of MS index to which resource is allocated in the allocating duration table 102 shown in FIG. 13, allocates the resource index p to the MS index n, and goes to step 2009.

At step 2009, the unit updates the rest of allocating duration 1304 to 1.

At step 2010, the unit recalculates and updates cost function values of the MS index n to which the resource has been allocated and returns to step 2006. When a resource is allocated to a mobile station, the transmission rate for the mobile station increases. Thus, it is preferable to lower the priority of the mobile station to which the resource has been allocated in the next resource allocation. When calculating cost function values by Equation 6, if previous resource allocation to a mobile station is done, the average transmission rate for the mobile station should be modified, as in Equation 7.

Rₙ(t)=Rₙ(t)+γₚₙ [Equation 7]

At step 2007, if allocation to the MS index n is complete, the unit goes to step 2011.

At step 2011, if required allocation to all mobile stations is not complete, the unit goes to step 2012.

At step 2012, the unit initializes all cost function values of the MS index n to −1 and returns to step 2006.

At step 2011, if required allocation to all mobile stations is complete, the unit goes to step 2013.

At step 2013, the unit decrements the rest of allocating duration 1304 by 1 for all allocated resources and terminates the processing.

The flowchart of FIG. 20 is not limited to the foregoing and its variants are possible, provided that the process includes additionally allocating non-guaranteed resources to mobile stations besides the allocation of guaranteed resources and setting the duration of allocation of non-guaranteed resources shorter than that of guaranteed resources. For calculating cost function values at step 2003, any other formula may be used, provided that it prioritizes respective resources for each mobile station.

For updating cost function values at step 2010, any other algorithm is possible, not limited to Equation 7, provided that it coordinates with the algorithm for calculating cost function values at step 2003.

Although it is assumed to allocate and reallocate resources on a per-frame basis in the present embodiment, it may be assumed to allocate and reallocate resources in units of R (R>1) frames. In this case, R or an integral multiple of R is set in the column of the rest of allocating duration 1304 of the allocating duration table 102 shown in FIG. 13 and, in the flowchart of FIG. 20, the rest of allocating duration is updated to R at step 2009 and decremented by R at step 2013.

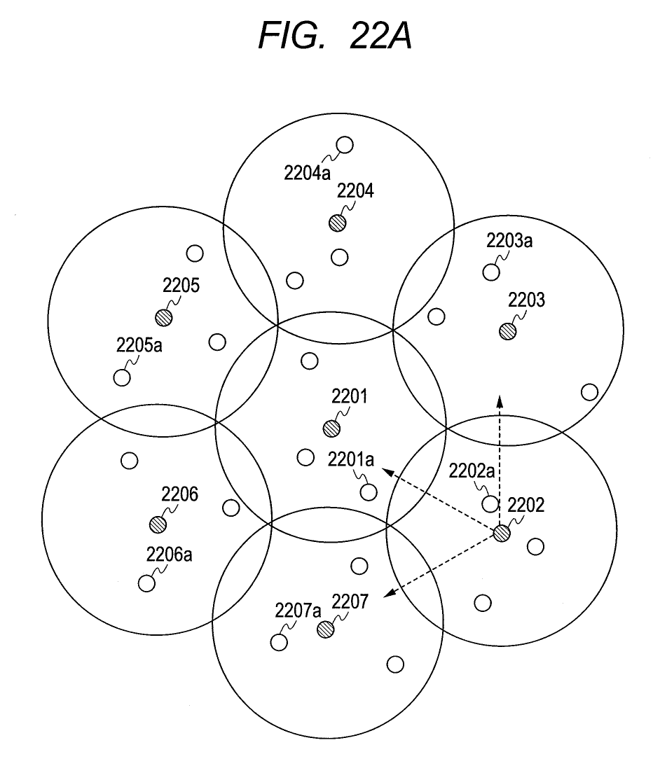

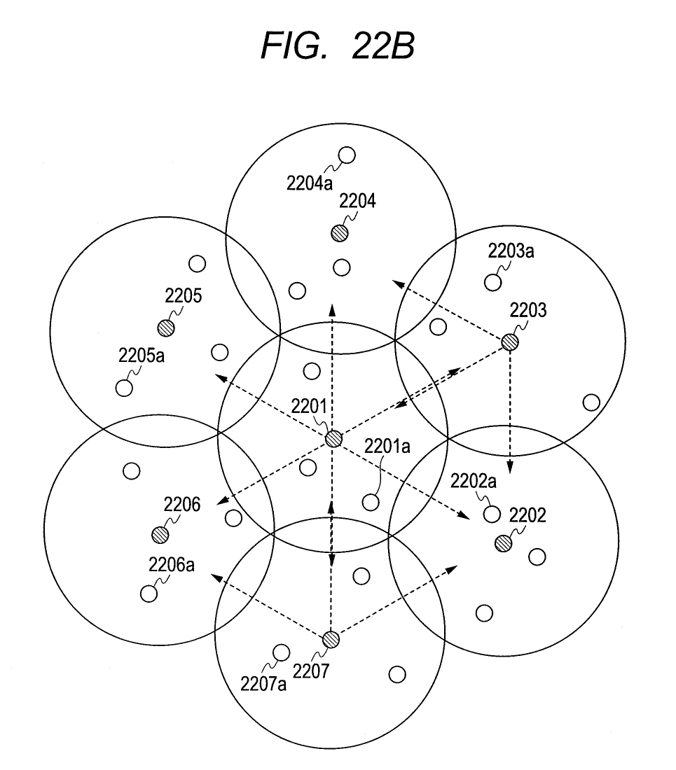

Resource allocation operation in the whole wireless communication system relevant to the present embodiment is described using FIGS. 22A and 22B. In the present embodiment, resources having small interference fluctuation values are judged as guaranteed resources and allocated for a long duration. Thus, the rest of allocating duration 1304 as in FIG. 13 for these resources is set longer. It is assumed that base stations 2201-2207 are deployed as shown in FIGS. 22A and 22B and communicate with mobile stations 2201a-2207a. In FIG. 22A, if a base station 2202 classifies and allocates guaranteed resources for a long duration, it gives interference on mobile stations 2201a, 2203a, 2207a served by base stations 2201, 2203, 2207 in the vicinity of the base station 2202. When the mobile stations 2201a, 2203a, 2207a measure the interference and reports it to the base stations 2201, 2203, 2207 and the base stations 2201, 2203, 2207 measure interference fluctuation values, there is a small fluctuation in interference values reported with regard to the guaranteed resources because of long duration of their allocation and thus their interference fluctuation values are small. In consequence, the guaranteed resources classified and allocated for a long duration by the base station 2202 are more likely to be classified as guaranteed resources by the base stations 2201, 2203, 2207 as well and allocated for a long duration. In turn, the interferences of the guaranteed resources at the base stations 2201, 2203, 2207 further have influence on base stations 2204, 2205, 2206, as shown in FIG. 22B and these resources are more likely to be selected as guaranteed resources similarly. In this way, the interferences arising from guaranteed resources have influence on mobile stations served by other base stations and these resources more tend to be classified again as guaranteed resources with small interference fluctuation values. As above, due to that a plurality of base stations allocate resources with small interference fluctuation values for a long duration, the same guaranteed resources more tend to be allocated by a plurality of base stations. Then, a small fluctuation in interference arising from guaranteed resources means that the interference of the resources when allocated is not much different to the interference at actual data reception and this interference is easy to predict. Thus, a stable transmission rate is achieved by allocating guaranteed resources. Non-guaranteed resources are taken as those for more flexible and additional allocation. These resources are allocated for a short duration and reallocated depending on interference values, thereby a high transmission rate can be achieved.

Further, the advantageous effect of the present embodiment is described in perspective of QoS. FIG. 44A shows an example where a service with a QoS parameter of a minimum sustained rate is transmitted by a related art method. When a packet arrives at a base station, the base station allocates resources and transmits data to a mobile station. Here, an actual transmission rate is virtually equivalent to a reception rate 4403a receiving data. In the related art method, the base station, when transmitting data, cannot predict interference when the data is received by the mobile station. Consequently, the data amount receivable by the mobile station is significantly smaller than the data amount transmitted from the base station. The reception rate 4403a becomes significantly lower than the transmission rate 4402a as indicated by a circle 4404a. It is supposed that the minimum sustained rate 4401 cannot be guaranteed. By contrast, in the present embodiment, guaranteed resources enough to guarantee the minimum sustained rate are allocated. Thus, interference becomes easy to predict and there is a small difference between the data amount transmitted by the base station and the data amount receivable by the mobile station. This resource allocation method suppresses lowing of the reception rate 4403a from the transmission rate 4402a as indicated by a circle 4404b in FIG. 44B and enables providing the service at the minimum sustained rate. This method also flexibly allows for a varying transmission rate by allocating not-guaranteed resources.

### Second Embodiment

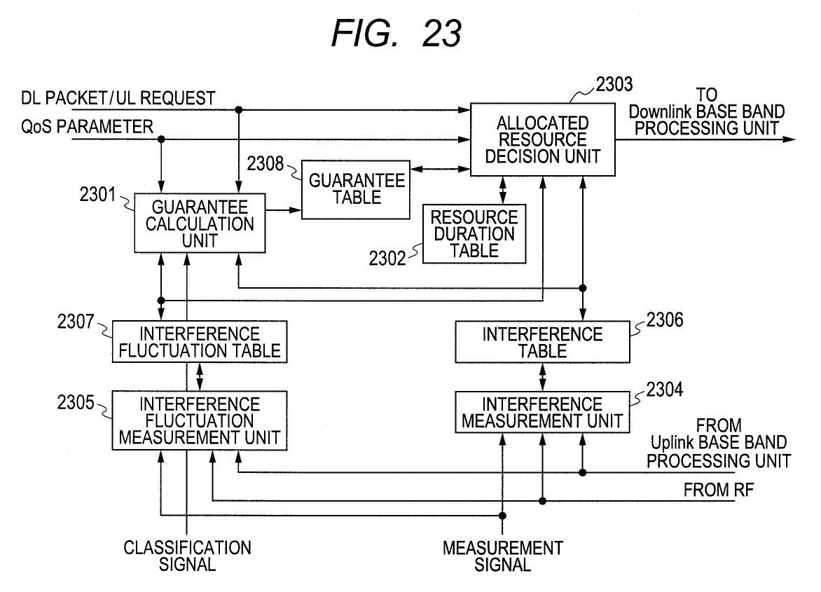

A second embodiment as another example of embodiment of the present invention is described below. In the second embodiment, as can be seen in a block structural diagram of the scheduling unit of a base station, as is shown in FIG. 23, the guaranteed resource classification unit in the base station of the first embodiment is changed to a guarantee calculation unit to calculate the guarantee of respective resources for each mobile station. In the structure of the second embodiment, guarantee table 2308 to store calculated guarantees is added to the base station (scheduling unit). Specifically, the calculating unit calculates guarantees corresponding to priority levels for classifying guaranteed resources from interference fluctuation values and interference values for pairs of mobile stations and resources. When allocating resources, a resource having the highest guarantee among the respective resources for each mobile station is classified as guaranteed type and allocated for a long duration.

An interference measurement unit 2304, a interference fluctuation measurement unit 2305, an interference table 2306, an interference fluctuation table 2307, and a allocating duration table 2302 are the same as in the first embodiment. The structure of a allocated resource decision unit 2303 is the same as in FIG. 18 and includes the same additional allocation unit 1802 as in the first embodiment.

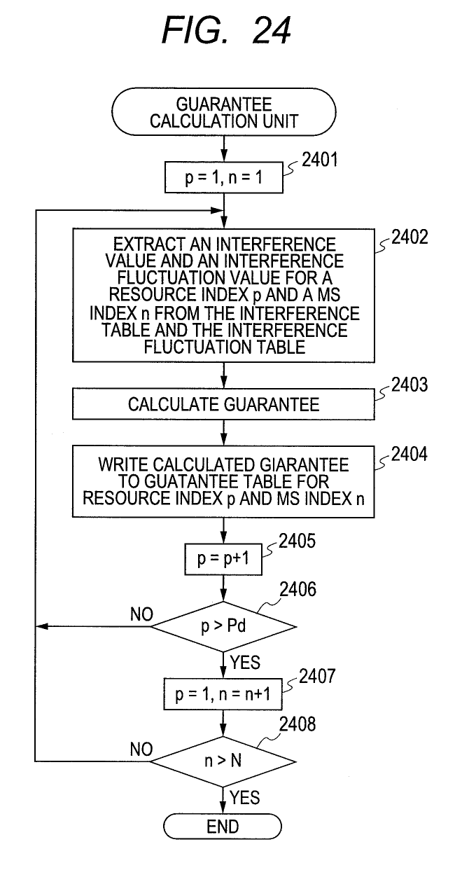

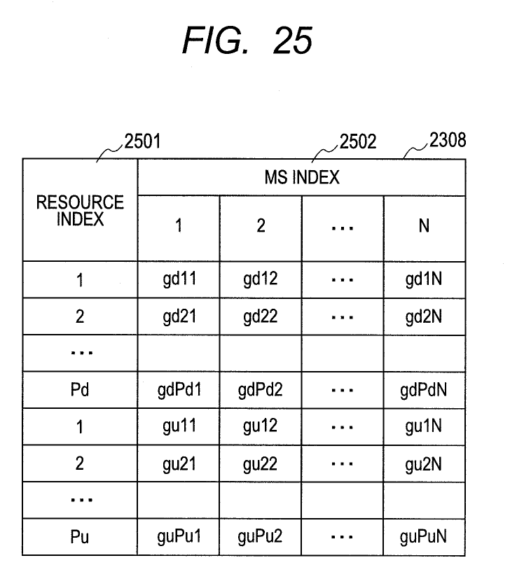

The guarantee calculation unit 2301 calculates guarantees and stores them into a guarantee table 2308, in which a resource with a higher guarantee is more likely to be classified as guaranteed type. The guarantee table 2308 is shown in FIG. 25. A column 2501 represents a resource index, a column 2502 represents a MS index, and calculated guarantees are stored in this table. A flowchart of the guarantee calculation unit 2301 is shown in FIG. 24.

At step 2401, the unit initializes the resource index to p=1 and the MS index to n=1.

At step 2402, the unit extracts an interference value γpn and an interference fluctuation value βpn from the interference table 2306 and the interference fluctuation table 2307.

At step 2403, the unit calculates a guarantee from the interference value γpn and interference fluctuation value βpn according to Equation 8 below.

$${g}_{pn} = \frac{{γ}_{pn}}{{β}_{pn}} \qquad [ Equation 8 ]$$

At step 2404, the unit stores the calculated guarantee into the guarantee table 2308.

At step 2405, the unit increments the resource index.

At step 2406, if p≦Pd, that is, calculating guarantees for all resources is not complete, the unit returns to step 2402. If p>Pd, that is, calculating guarantees for all resources is complete, the unit goes to step 2407.

At step 2407, the unit initializes the resource index to p=1 and increments the MS index.

At step 2408, if n≦N, that is, calculating priority levels for all mobile stations is not complete, the unit returns to step 2402. if n>N, that is, calculating priority levels for all mobile stations is complete, the unit terminates the processing.

For calculating the guarantee at step 2403, any other algorithm, not limited to Equation 8, is possible, provided that it gives a higher guarantee to a resource and a mobile station having a smaller interference fluctuation value. For example, instead of using interference values, average interference values for a long period may be used to set up a classifying policy so that resources having a smaller fluctuation and a higher average value are more likely to be classified as guaranteed type.

The flowchart of FIG. 24 is not limited to the foregoing and its variants are possible, provided that the process includes calculating a guarantee so that a higher guarantee will be given to a resource and a mobile station having a smaller interference fluctuation value, and storing the guarantee into the guarantee table 2308.

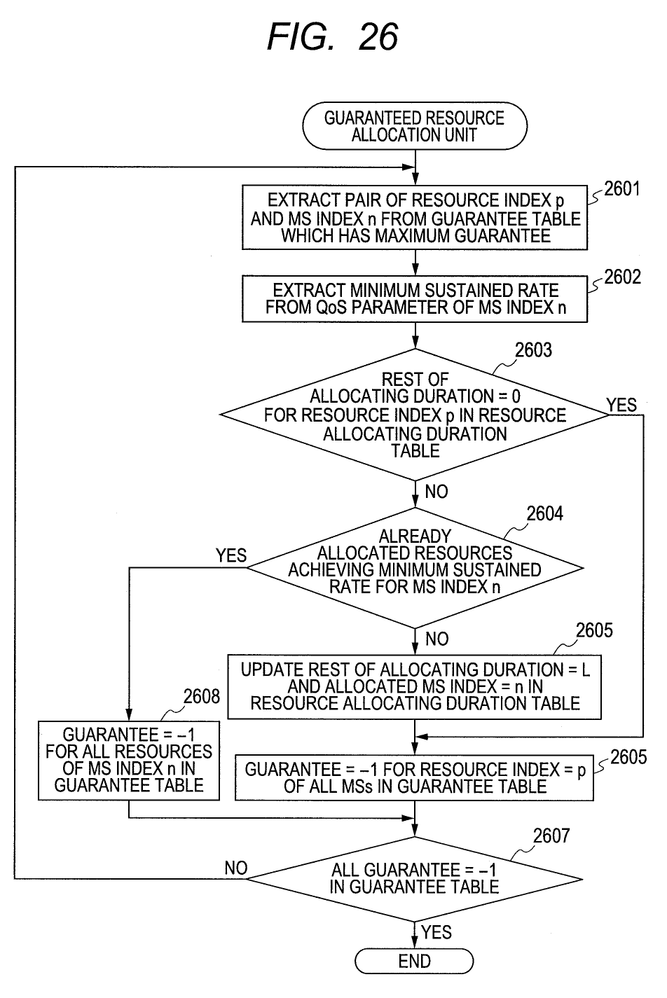

The guaranteed allocation unit 1801 in the allocated resource decision unit 2303 refers to the guarantee table 2308, regards pairs of mobile stations and resources with higher guarantees as guaranteed resources in descending order of guarantee, allocates them, and sets their duration of allocation longer in the allocation duration table. A flowchart of this operation is shown in FIG. 26.

At step 2601, the unit refers to the guarantee table 2308 and extracts a resource index p and a MS index n having the highest guarantee.

At step 2602, the unit extracts a minimum sustained rate from a QoS parameter for the extracted MS index n, as in the first embodiment.

At step 2603, if the rest of allocating duration is not 0 for the resource index p in the allocating duration table 2302 shown in FIG. 13, that is, indicating that the resource is guaranteed type, the unit goes to step 2604.

At step 2604, if resource allocation yielding up to the minimum sustained rate have to the MS index n is not complete, the unit goes to step 2605.

At step 2605, the unit updates the MS index to which the resource index p is allocated to n in the column of MS index to which resource is allocated in the allocating duration table 2302 shown in FIG. 13, allocates the resource to the mobile station, and sets the rest of allocating duration for the resource to L (L>1).

At step 2606, the units sets guarantee=−1 for all mobile stations associated with the resource index p in the guarantee table 2308, so that the resource index p will not be selected subsequently.

At step 2604, if resource allocation yielding up to the minimum sustained rate have to the MS index n is complete, the unit goes to step 2608.

At step 2608, the units sets guarantee=−1 for all resources associated with the MS index n in the guarantee table 2308, so that the MS index n will not be selected subsequently, and goes to step 2607.

At step 2607, if not all values of guarantee in the guarantee table 2308 are −1, that is, allocation of guaranteed resources is not complete, the unit returns to step 2601. if all values of guarantee in the guarantee table 2308 are −1, that is, allocation of guaranteed resources is complete, the unit terminates the processing.

Setting guarantee=−1 in steps 2606 and 2608 is not restrictive; guarantee may be set to any other value, so that the resource or mobile station will not be selected subsequently. For example, guarantee may be set to a negative largest value.

The flowchart of FIG. 26 is not limited to the foregoing and its variants are possible, provided that the process includes selecting and allocating pairs of resources and mobile stations with higher guarantees as guaranteed resources in descending order of guarantee and setting their duration of allocation longer.

Resources not allocated by the guaranteed allocation unit are in turn allocated by the additional allocation unit, as in the first embodiment.

In the second embodiment, in addition to the effect achieved by the first embodiment, it is possible to identify guaranteed resources on a per-mobile station basis and to improve the stability of a transmission rate.

### Third Embodiment

A third embodiment as another example of embodiment of the present invention is described below.

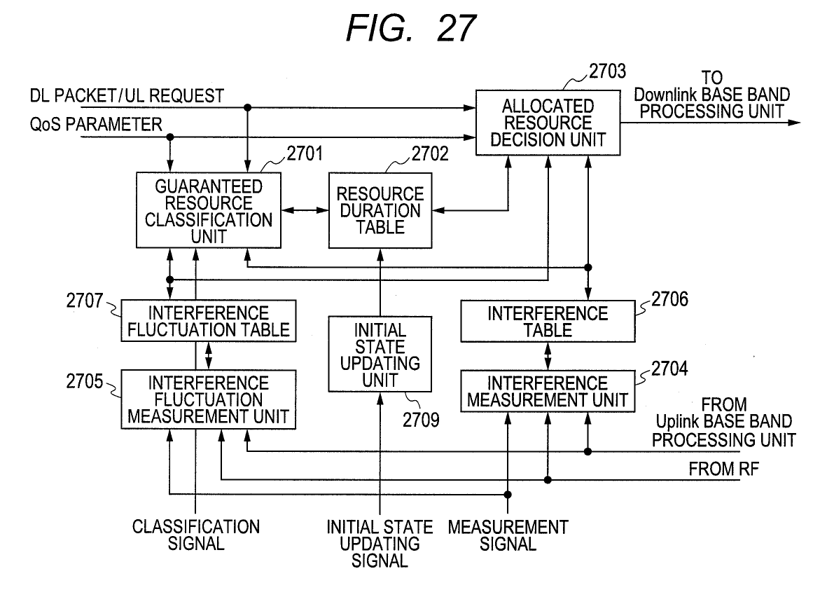

In the third embodiment, as can be seen in a block structural diagram of the scheduling unit of a base station, as is shown in FIG. 27, an initial state updating unit 2709 is added to the base station (scheduling unit). In response to receiving an initial reconfigure signal to instruct to initially reconfigure the allocating duration table, the initial state updating unit 2709 initially reconfigures the allocating duration table 102 in the first and second embodiments and sets up guaranteed resources in advance. While

FIG. 27 shows the structure in which the initial state updating unit is added to the base station (scheduling unit) of the first embodiment, this unit may also be added to the base station (scheduling unit) of the second embodiment.

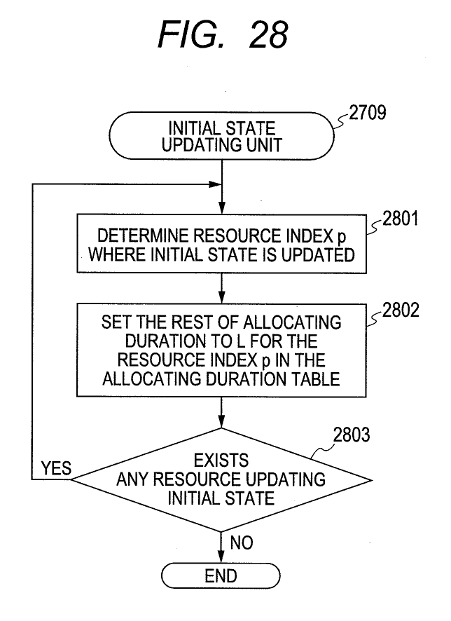

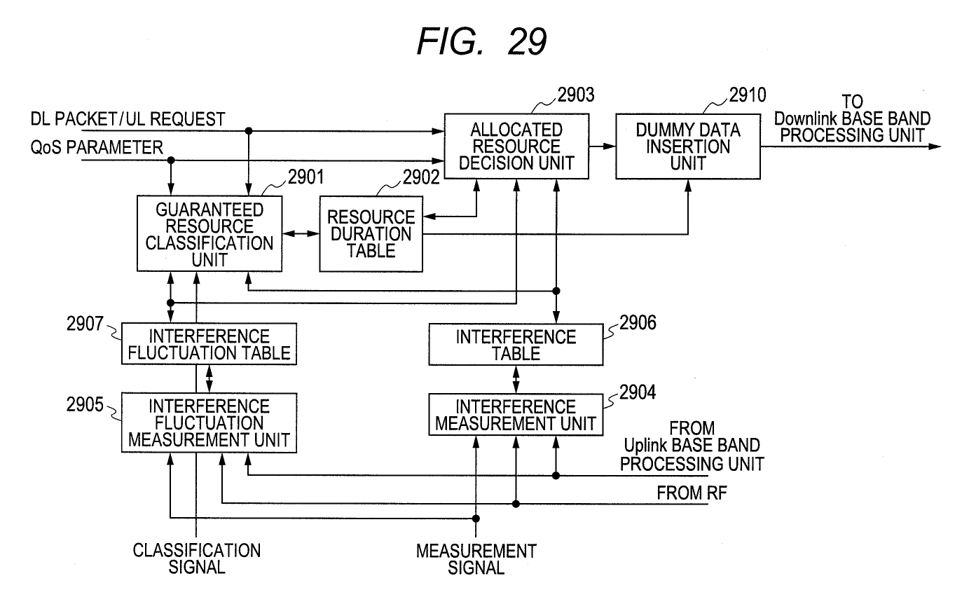

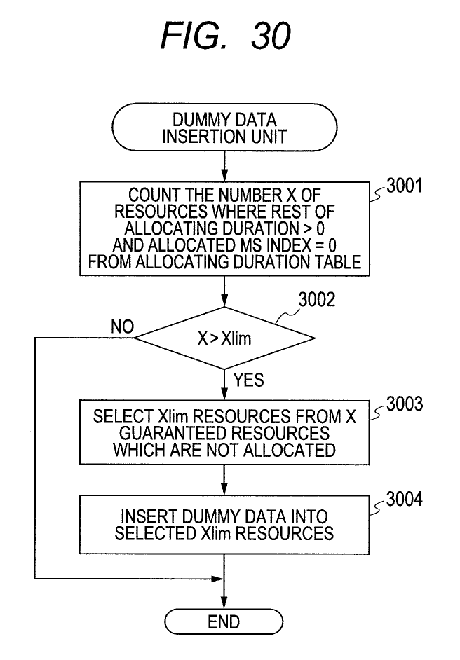

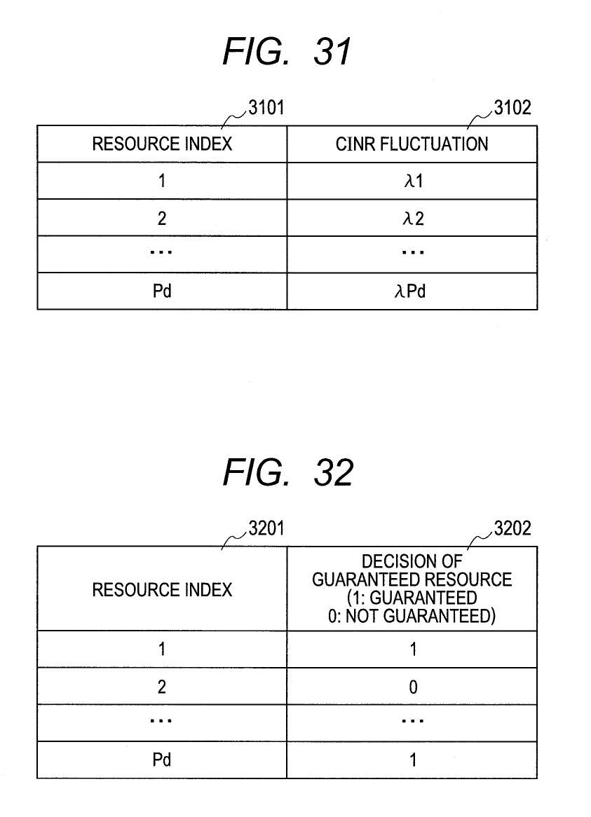

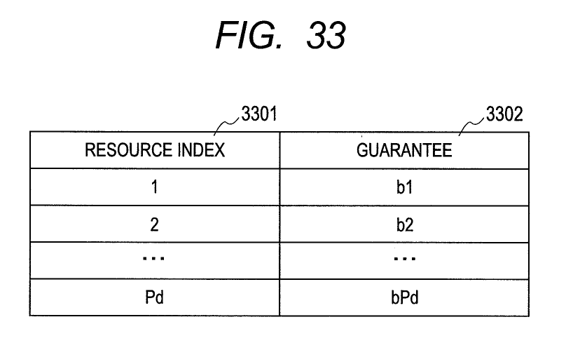

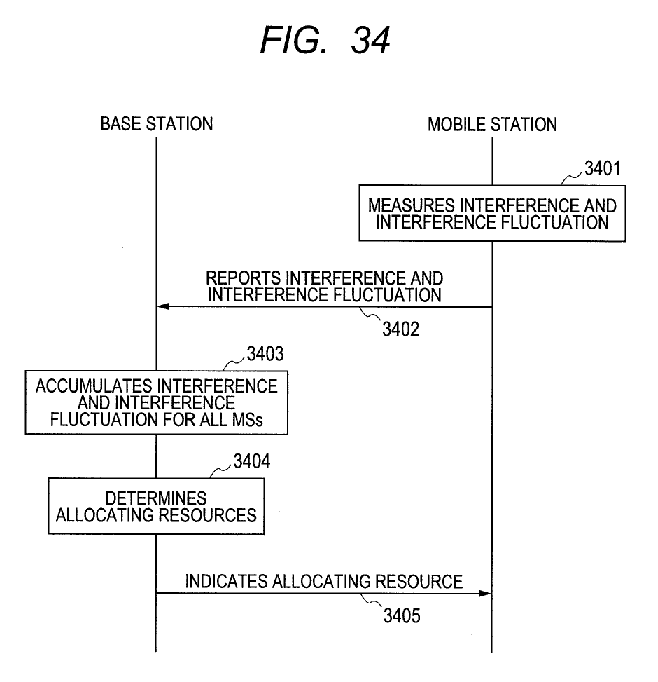

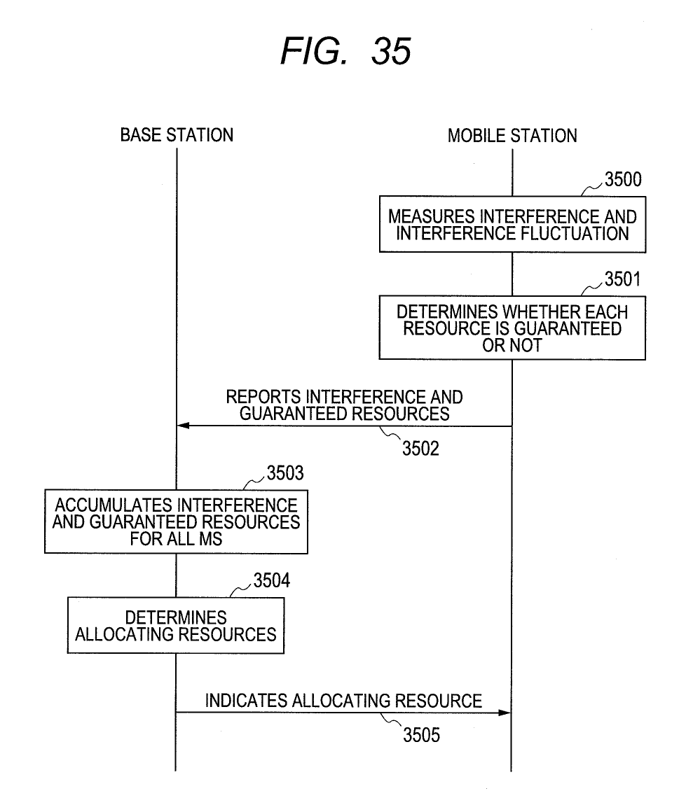

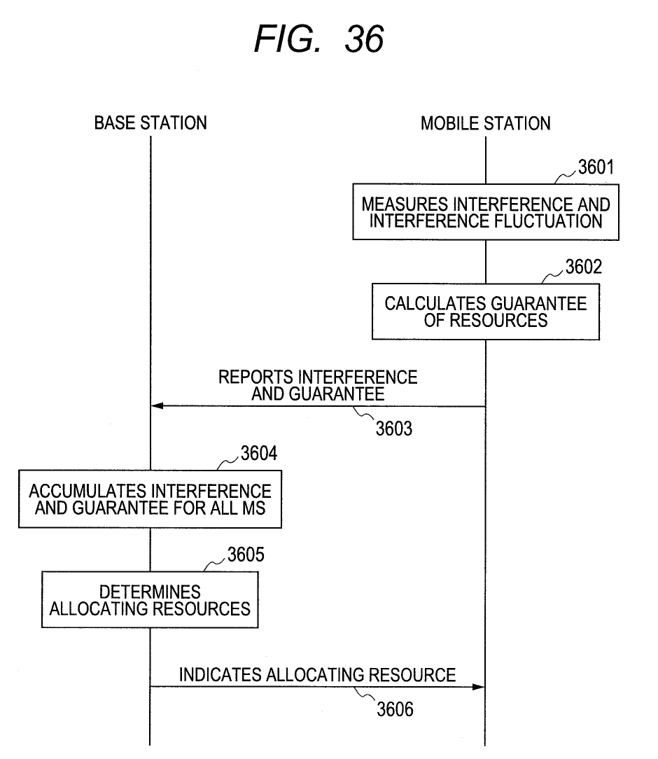

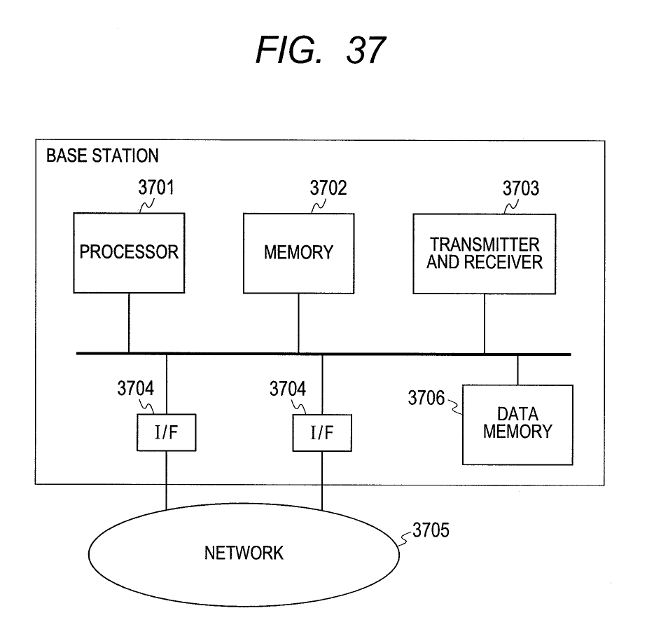

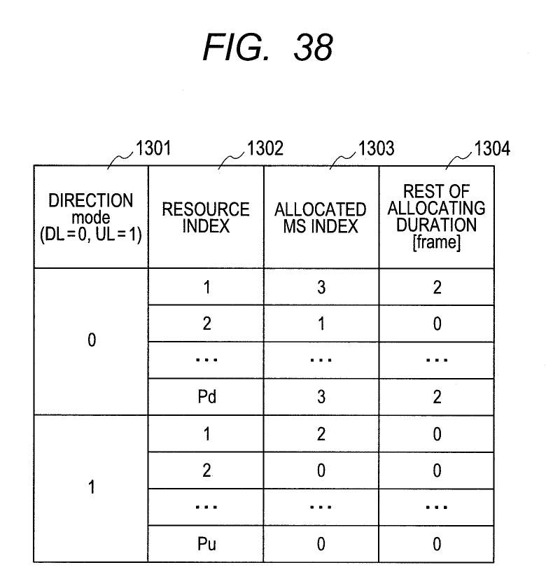

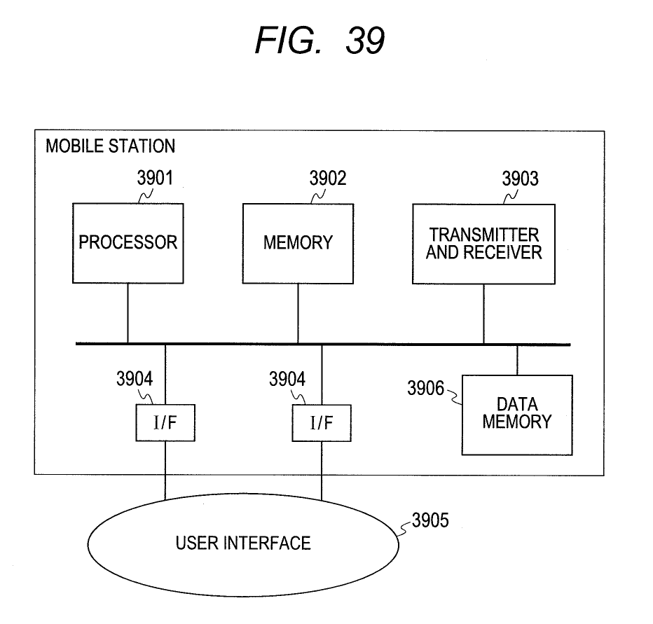

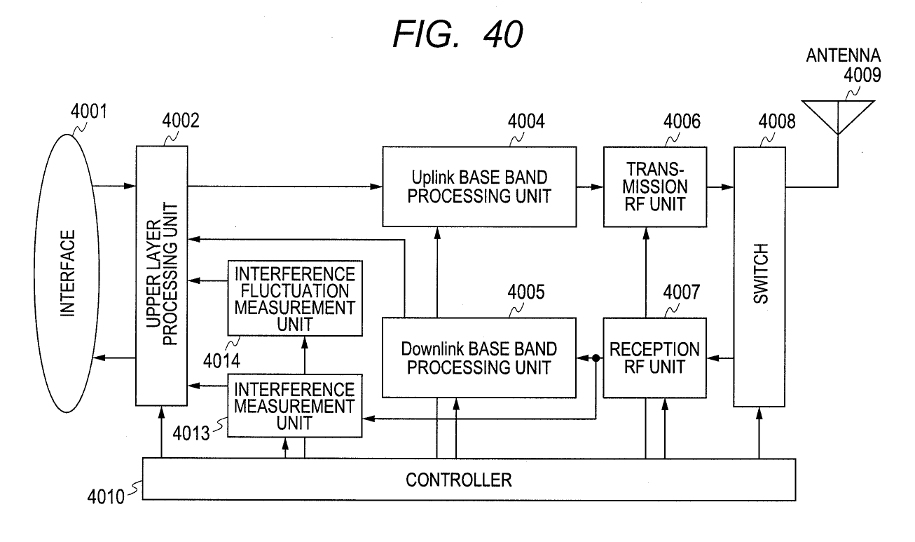

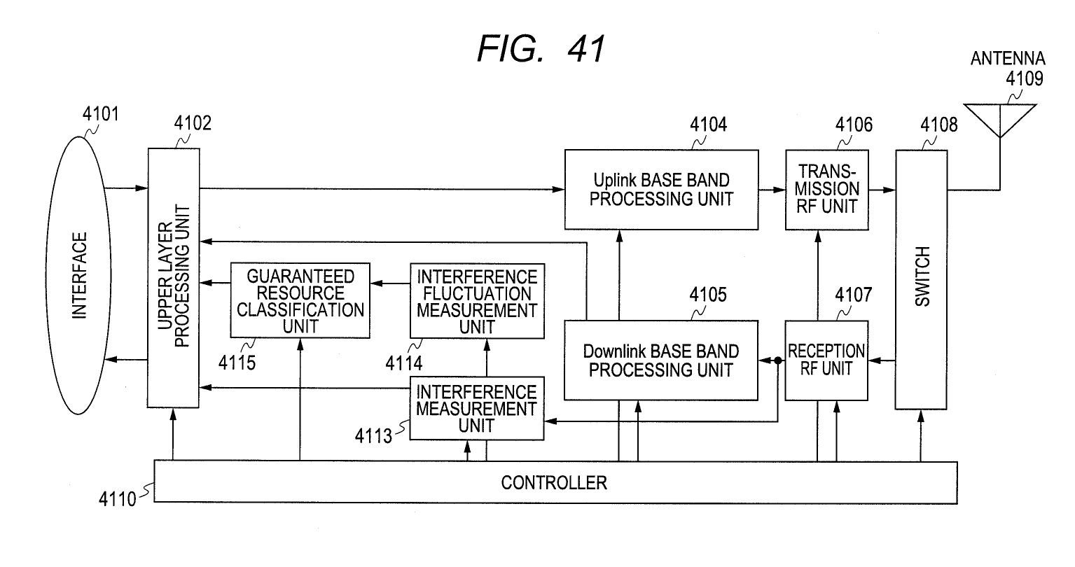

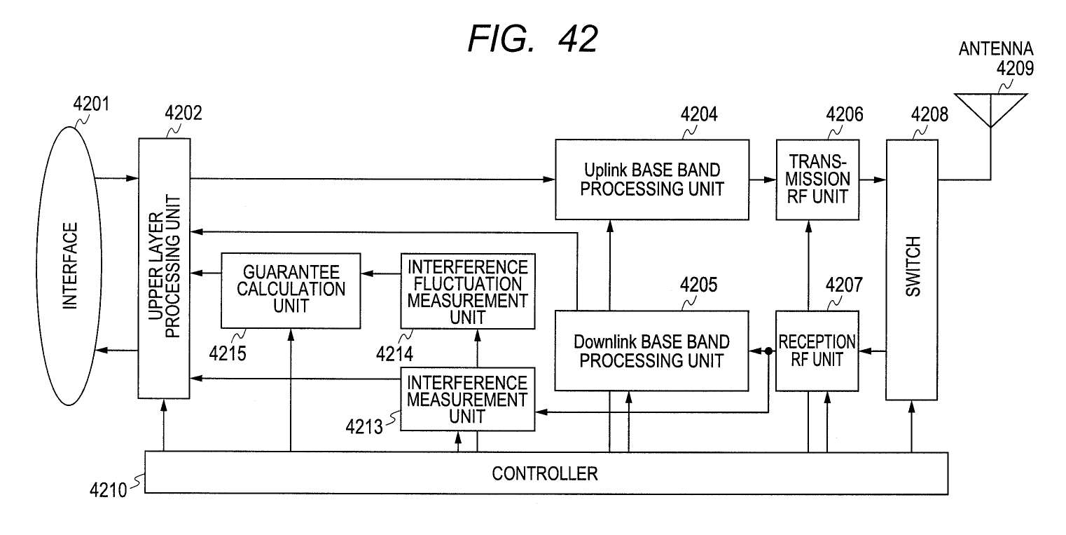

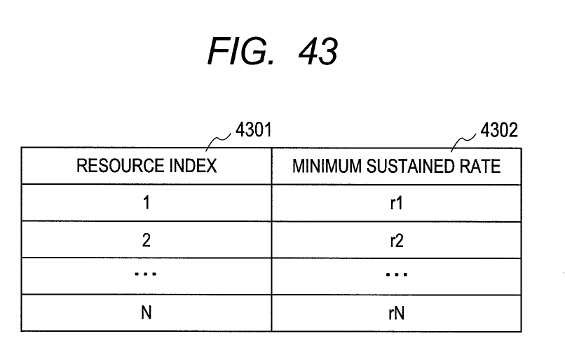

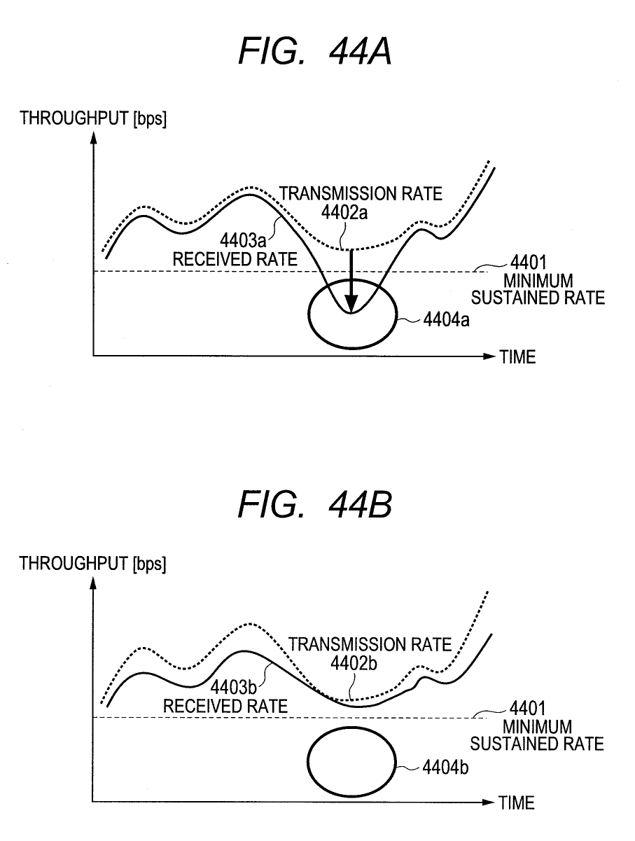

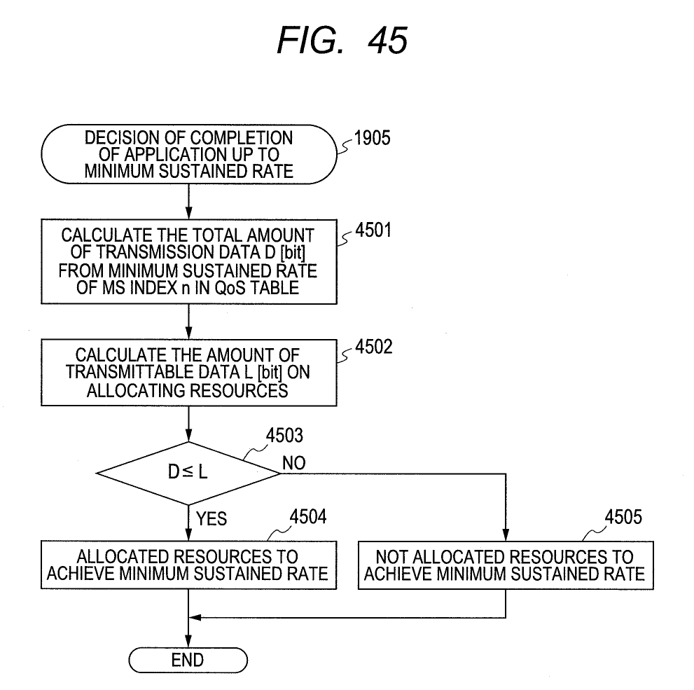

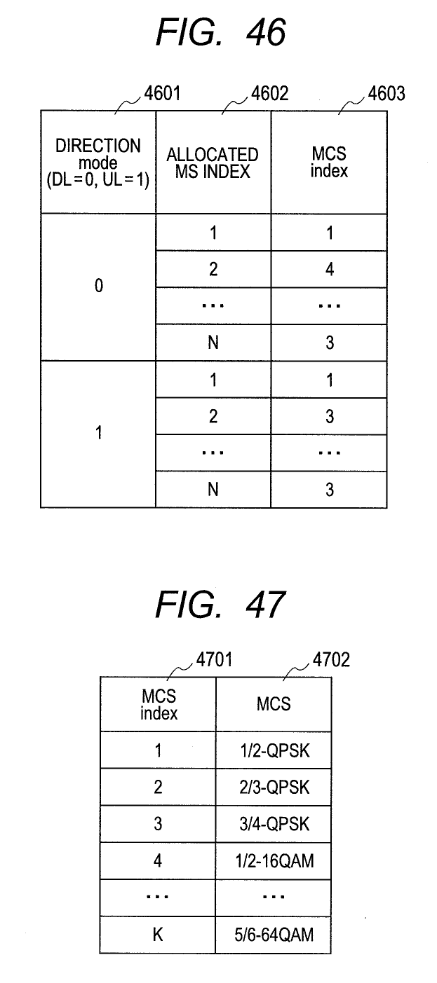

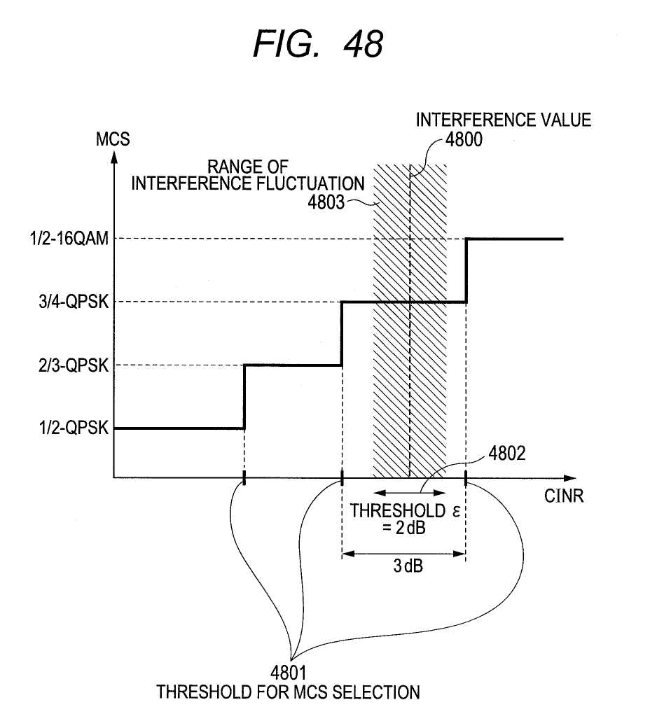

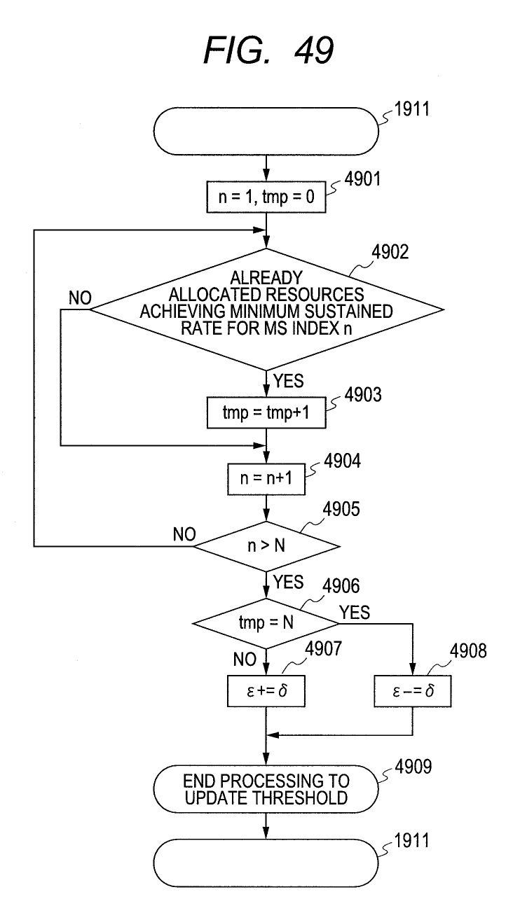

A flowchart of operations of the initial state updating unit 2709 is shown in FIG. 28.

At step 2801, the unit decides a resource index p where the initial state is to be updated.

At step 2802. the unit sets the rest of allocating duration 1304 to L for the resource index p in the allocating duration table.

At step 2803, if there is a resource whose initial state is to be updated, the unit returns to step 2801. If there is no resource whose initial state is to be updated, the unit terminates the processing.

In step 2801, a resource index p may be determined in any manner; for example, it may be determined randomly.

In step 2803, a criterion for deciding whether there is a resource whose initial state is to be updated may be set in an arbitrary manner. For example, a number of resources to be taken as guaranteed type may be set and the process may be repeated until the set number of resources is reached.

The flowchart of FIG. 28 is not limited to the foregoing and its variants are possible, provided that the process includes reconfiguring the allocating duration table in which all values of the rest of allocating duration 1304 are 0 and initially classifying part of resources as guaranteed resources.

In addition to the effect achieved by the first embodiment, the third embodiment provides an advantageous effect, i.e., it is possible to reduce time before plural base stations share guaranteed resources by initially setting up guaranteed resources in the allocating duration table.

### Fourth Embodiment

A fourth embodiment as another example of embodiment of the present invention is described below. In the fourth embodiment, a dummy data insertion unit 2910 is added to the base station (scheduling unit), as is shown in FIG. 29. The dummy data insertion unit 2910 refers to the allocating duration table, identifies guaranteed resources not allocated, and inserts dummy data in such resources for transmission. Thereby, fluctuation in interference on other base stations is decreased. While FIG. 29 shows an instance where the dummy data insertion unit 2910 is applied in the base station (scheduling unit) of the first embodiment, this unit may also be applied in the base station (scheduling unit) of other embodiments.

A flowchart of operations of the dummy data insertion unit 2910 is shown in FIG. 30.

At step 3001, from the allocating duration table, the unit, counts the number X of resources for which the rest of allocating duration>0, i.e., indicating guaranteed resources and allocated MS index=0, i.e., no allocation of the resource to a mobile station is done.

At step 3002, the unit compares X to a threshold Xlim with regard to the number of guaranteed resources not allocated. If X>Xlim, the unit goes to step 3003. If X≦Xlim, the unit terminates the processing.

At step 3003, the unit randomly chooses a number Xlim of resources from the X guaranteed resources not allocated.

At step 3004, the unit inserts dummy data in the resources selected at step 3003 and terminates the processing. Here, dummy data may be arbitrary and is discarded when received.

Randomly selecting a number Xlim of resources in step 3003 is not restrictive; it is only required to choose a number Xlim of resources. Further, the flowchart of operations of the dummy data insertion 2910 is not limited to the foregoing and its variants are possible, provided that the process includes selecting a thresholded number of guaranteed resources not allocated and inserting dummy data therein.

In addition to the effect achieved by the first embodiment, the fourth embodiment makes it possible to prevent increase of fluctuation in interferences arising from guaranteed resources not allocated to mobile stations, even in a situation where, from a plurality of mobile stations, packets of a sufficient data amount to yield a minimum sustained rate do not arrive at a base station due to network congestion, service disruption, etc. In other words, the fourth embodiment makes it possible to share guaranteed resources among base stations, as described using FIGS. 22A and 22B in the first embodiment, even in a situation where, from a plurality of mobile stations, packets of a sufficient data amount to yield a minimum sustained rate do not arrive at a base station.

### Fifth Embodiment

A fifth embodiment as another example of embodiment of the present invention is described below.

It is assumed that mobile stations report interference values in the first to fourth embodiments. In contrast, in the fifth embodiment, a mobile station is provided with the interference measurement unit 104 and the interference fluctuation measurement unit 105 residing in a base station and reports results calculated by the above units to a base station. A block structural diagram of a mobile station including software-implemented components is shown in FIG. 40. This mobile station has a structure in which a interference fluctuation measurement unit 4014 is added to the block structural diagram of FIG. 8. The hardware structure of the mobile station is the same as in FIG. 39. The interference fluctuation measurement unit 4014 is a program module which is executed by the processor 3901 and this and other program modules are stored in the memory 3902.

A sequence of scheduling in the fifth embodiment is shown in FIG. 34. First, at 3401, a mobile station measures interference and interference fluctuation values and creates an interference fluctuation table including the columns of resource index 3101 and CINR fluctuation 3102, as is shown in FIG. 31. Then, at 3402, the mobile station reports part or all of the interference and Interference fluctuation values to a base station. As in FIG. 31, the mobile station reports CINR fluctuation X as an interference fluctuation value by way of example. An algorithm for calculating the interference fluctuation value is the same as described with regard to FIG. 15 in the first embodiment. However, steps 1501, 1502, 1510, 1511 are dispensed with, because identifying a MS index is not needed. The interference fluctuation table on each mobile station corresponds to the table shown in FIG. 12, but having one MS index column for the mobile station. In this case, in order that the base station decides resources allocated from reported interference fluctuation values, the base station needs to know the algorithm for calculating the interference fluctuation value. However, interference fluctuation values that are reported from a mobile station are not limited to CINR, any other metric indicating a degree of fluctuation in interference may be used.

At 3403, the base station accumulates reported interference and interference fluctuation values in the interference table and the interference fluctuation table as described in the first embodiment. Subsequent sequence is the same as for resource allocation in the first embodiment.

According to the fifth embodiment, in addition to the effect achieved by the first embodiment, mobile stations perform the above-described report and this can contribute to decreasing the number of circuits needed for classifying guaranteed resources in a base station and manufacturing a base station at less cost. Also, this can contribute to power saving of a base station in resource allocation.

### Sixth Embodiment

A sixth embodiment as another example of embodiment of the present invention is described below.

In the sixth embodiment, a mobile station described in the fifth embodiment is further provided with a guaranteed resource classification unit 101 and reports resource indices judged as guaranteed resources to a base station. A block structural diagram of a mobile station including software-implemented components is shown in FIG. 41. This mobile station has a structure in which a guaranteed resource classification unit 4115 is added to the block structural diagram of FIG. 40. The hardware structure of the mobile station is the same as in FIG. 39. The guaranteed resource classification unit 4115 is a program module which is executed by the processor 3901 and this and other program modules are stored in the memory 3902. A sequence of scheduling in the sixth embodiment is shown in FIG. 35. As in the fifth embodiment, first, at 3500, a mobile station measures interference and interference fluctuation values and creates an interference fluctuation table as shown in FIG. 31. Then, the mobile station decides whether each resource is guaranteed type at 3501 and creates a guaranteed resource decision table as is shown in FIG. 32. This table includes the columns of resource index 3201 and decision of guaranteed resource 3202 and indicates whether each resource is guaranteed type. In FIG. 32, resource indices 1, Pd are guaranteed, but a resource index 2 is not guaranteed. After that, the mobile station reports part or all of results of the decision to a base station at 3502. An algorithm for deciding whether a resource is guaranteed is the same as the operations that are performed by the guaranteed resource classification unit, as described with regard to FIG. 16 and FIG. 17 in the first, third, and fourth embodiments. However, steps 1611, 1606, 1607 in FIG. 16 are dispensed with and no MS index n is set, because identifying a MS index is not needed and only whether a resource is guaranteed should be decided. Step 1609 is changed to an action that updates the column of decision of guaranteed resource to 1 for a resource index p in the table of FIG. 32. The flowchart of FIG. 17 is also modified as above.

At 3503, the base station accumulates reported interference values and results of guaranteed resource decision in the interference table and the allocating duration table. Subsequent operations of resource allocation performed by the base station, based on whether each resource is guaranteed are the same as in the first embodiment. However, results of decision as to whether a resource is guaranteed reported from mobile stations are not limited to the foregoing. Any information indicating whether each resource is guaranteed is possible.

According to the sixth embodiment, in addition to the effect achieved by the first embodiment, mobile stations perform the above-described report and this can contribute to decreasing the number of circuits needed for classifying guaranteed resources in a base station and manufacturing a base station at less cost. Also, this can contribute to power saving of a base station in resource allocation.

### Seventh Embodiment

A seventh embodiment as another example of embodiment of the present invention is described below.

In the seventh embodiment, a mobile station described in the fifth embodiment is further provided with a guarantee calculation unit 2301 and reports guarantee to a base station. A block structural diagram of a mobile station including software-implemented components is shown in FIG. 42. This mobile station has a structure in which a guarantee calculation unit 4215 is added to the block structural diagram of FIG. 40. The hardware structure of the mobile station is the same as in FIG. 39. The guarantee calculation unit 4215 is a program module which is executed by the processor 3901 and this and other program modules are stored in the memory 3902. A sequence of scheduling in the seventh embodiment is shown in FIG. 36. As in the fifth and sixth embodiments, first, at 3601, a mobile station measures interference fluctuation values, and creates a table including the columns of resource index 3301 and guarantee 3302, as is shown in FIG. 33. Then, at 3602, the mobile station reports all or part of the values of guarantees to a base station. An algorithm for calculating the guarantee is the same as carried out by the guarantee calculation unit in the second embodiment and this algorithm is known by the base station. In order that the base station decides resources allocated from reported guarantee values, the base station needs to know the algorithm for calculating the. However, any other algorithm not limited to the algorithm presented herein is possible, provided that it gives a metric indicating a resource more likely to be selected as guaranteed type. Operations of resource allocation performed by the base station, based on the guarantee, are the same as described with regard to FIG. 24 in the second embodiment. However, step 2408 in FIG. 24 is dispensed with and no MS index n is set, because identifying a MS index is not needed.

At 3604, the base station accumulates reported interference values and guarantee values in the interference table and the guarantee table. Subsequent operations of resource allocation are the same as in the second embodiment.

According to the seventh embodiment, in addition to the effect achieved by the first embodiment, mobile stations perform the above-described report and this can contribute to decreasing the number of circuits needed for classifying guaranteed resources in a base station and manufacturing a base station at less cost. Also, this can contribute to power saving of a base station in resource allocation.

With regard to the fifth to seventh embodiments, while a mobile station holds measurement results per resource in the tables shown in FIGS. 31, 32, and 33, a mobile station may hold measurement results per resource group, if resources are grouped. In that case, the resource index column of the tables shown in FIGS. 31, 32, and 33 is changed to a resource group number column. Accordingly, the number of records in these tables is reduced; i.e., the amount of memory required to store them and the amount of information to be reported can be reduced.

Other aspects of the present invention are set forth below.

A wireless base station apparatus, one of a plurality of wireless base station apparatuses capable of communication with a plurality of mobile station apparatuses via radio resources, the base station apparatus including a resource classification unit that classifies the radio resources into guaranteed resources to be allocated to one of the mobile station apparatuses and set to continue to be allocated during a preconfigured duration and second resources to be allocated to one of the mobile station apparatuses and set to continue to be allocated during a duration shorter than the preconfigured duration; a resource allocation unit that allocates the guaranteed resources for transmission/reception of data with a specified capacity and allocates the second resources for transmission/reception of data other than the data with a specified capacity; and a resource allocation notification unit that notifies the mobile station apparatuses of the results of allocation performed by the resource allocation unit.

A mobile station apparatus communicating with a wireless base station apparatus via radio resources, the mobile station apparatus including an interference fluctuation measurement unit that deriving from interferences of the radio resources a set of fluctuation values of the interferences; a radio resource classification unit that classifies the radio resources into guaranteed resources to be allocated by the wireless base station apparatus to the mobile station apparatus during a preconfigured duration and second resources to be allocated by the wireless base station apparatus to the mobile station apparatus during a duration shorter than the preconfigured duration, based on the set of fluctuation values; and a resource classification notification unit that notifies the wireless base station apparatus of the results of the classifying performed by the resource classification unit.

What is claimed is:

1. A wireless base station apparatus, one of a plurality of wireless base station apparatuses capable of communication with a plurality of mobile station apparatuses via radio resources, the base station apparatus comprising:
a processor that sorts the radio resources into first resources to be allocated to one of the mobile station apparatuses during a preconfigured duration and second resources to be allocated to one of the mobile station apparatuses during a duration shorter than the preconfigured duration, allocates the first resources for transmission/reception of data with a specified capacity among data to be transmitted/received and allocates the second resources for transmission/reception of data other than the data with a specified capacity among the data to be transmitted/received; and
a transmitter and receiver that notifies results of allocation performed by the processor to the mobile station apparatuses.

2. The wireless base station apparatus according to claim 1,
wherein the processor calculates the specified capacity based on a minimum sustained rate to be guaranteed during the communication.

3. The wireless base station apparatus according to claim 1,
wherein the processor derives from interferences of the radio resources a set of fluctuation values of the interferences, sorts radio resources having the interference values less than a preconfigured threshold value as the first resources, and sorts radio resources having the interference values not less than the threshold value as the second resources.

4. The wireless base station apparatus according to claim 1,
wherein the processor classifies a subset of the second resources as the first resources again, if the first resources do not suffice the specified capacity.

5. The wireless base station apparatus according to claim 1, further comprising:
a memory device to hold information for the mobile station apparatuses to which each of the radio resources is allocated and durations for which each of the radio resources is allocated.

6. A wireless base station apparatus, one of a plurality of wireless base station apparatuses capable of communication with a plurality of mobile station apparatuses via radio resources, the base station apparatus comprising:
a processor that derives from interferences of the radio resources a set of fluctuation values of the interferences, allocates the radio resources having smaller interference fluctuation to the mobile station apparatuses according to ascending order of the fluctuation values until sufficing a specified capacity among data to be transmitted/received, setting the thus allocated radio resources to continue to be allocated for a preconfigured duration, and allocates the radio resources to mobile station apparatuses after sufficing the specified capacity among the data to be transmitted/received, setting the thus allocated radio resources to continue to be allocated for a duration shorter than the preconfigured duration; and
a transmitter and receiver that notifies results of allocation performed by the processor to the mobile station apparatuses.

7. A wireless communication system comprising a plurality of wireless base station apparatuses and a plurality of mobile station apparatuses, wherein the wireless base station apparatuses and the mobile station apparatuses are capable of communication with each other via radio resources,
each of the base station apparatuses including:
a resource classification unit that classifies the radio resources into first resources to be allocated to one of the mobile station apparatuses during a preconfigured duration and second resources to be allocated to one of the mobile station apparatuses during a duration shorter than the preconfigured duration;
a resource allocation unit that allocates the first resources for transmission/reception of data with a specified capacity among data to be transmitted/received and allocates the second resources for transmission/reception of data other than the data with a specified capacity among the data to be transmitted/received; and
a resource allocation notification unit that notifies the mobile station apparatuses of the results of allocation performed by the resource allocation unit.

8. The wireless communication system according to claim 7,
wherein the resource allocation unit calculates the specified capacity based on a minimum sustained rate to be guaranteed during the communication.

9. The wireless communication system according to claim 7,
wherein each of the wireless base station apparatuses further include an interference fluctuation measurement unit that derives from interferences of the radio resources a set of fluctuation values of the interferences, and
wherein the resource classification unit classifies radio resources having the interference values less than a preconfigured threshold value as the first resources and classifies radio resources having the interference values not less than the threshold value as the second resources.

10. The wireless communication system according to claim 7,
wherein the resource classification unit includes a table to hold information for the mobile station apparatuses to which each of the radio resources is allocated and durations for which each of the radio resources is allocated.

11. A mobile station apparatus communicating with a wireless base station apparatus via radio resources, the mobile station apparatus comprising:
an interference fluctuation measurement unit that derives from interferences of the radio resources a set of fluctuation values of the interferences; and
an interference fluctuation value notification unit that notifies the wireless base station apparatus of the set of interference values.

12. A mobile station apparatus communicating with a wireless base station apparatus via radio resources, the mobile station apparatus comprising:
a receiver for receiving from the base station apparatus results of allocation including first resources allocated for transmission/reception of data with a specified capacity among data to be transmitted/received and set to continue to be allocated for a preconfigured duration and/or second resources allocated for transmission/reception of data other than the data with a specified capacity among the data to be transmitted/received and set to continue to be allocated for a duration shorter than the preconfigured duration; and
a processor for processing transmission/reception of data via the allocated resources.
